(19) United States
(12) Patent Application Publication
(10) Pub. No.: US 2015/0228239 A1
(43) Pub. Date: Aug. 13, 2015

(54) DISPLAY DEVICE AND METHOD OF DRIVING THE SAME

(71) Applicant: Sharp Kabushiki Kaisha, Osaka-shi, Osaka (JP)

(72) Inventors: Noriyuki Tanaka, Osaka-shi (JP); Kouji Kumada, Osaka-shi (JP)

(21) Appl. No.: 14/374,284

(22) PCT Filed: Feb. 1, 2013
(86) PCT No.: PCT/JP2013/052321

§ 371 Date: Jul. 24, 2014

(30) Foreign Application Priority Data
Feb. 7, 2012 (JP) 2012-023910

(51) Int. Cl. G09G 3/36

(52) U.S. Cl. CPC G09G 3/3648; G09G 2310/04; G09G 2320/103; G09G 2320/0261; G09G 2320/0257

(57) ABSTRACT

In a display control circuit (60) of an RAM through type, RGB data generated based on a command conformed to the DSI standard transmitted from a host (1) is supplied to a checksum circuit (33). The checksum circuit (33) obtains a checksum value of the RGB data and determines whether the RGB data is updated or not based on the obtained checksum value. In the case where the RGB data is updated, the RGB data is supplied to a latch circuit (34) and checksum process data indicating that the RGB data is updated is supplied to a timing generator (35), thereby immediately forced-refreshing an image displayed in a display unit (15).

### TECHNICAL FIELD

The present invention relates to a display device and a method of driving the display device and, more particularly, to a display device performing a pause driving and a method of driving the display device.

### BACKGROUND ART

Conventionally, for a display device displaying an image having little change such as a still image, a technique is proposed capable of switching between a normal driving in which a refresh rate is, for example, 60 Hz or higher and a pause driving (or also called a low-frequency driving or an intermittent driving) in which a refresh rate is, for example, lower than 60 Hz. Consequently, by performing an appropriate driving in accordance with an image to be displayed, the power consumption of the display device can be lowered.

For example, Patent Document 1 describes a display device in which a liquid crystal module is controlled by a liquid crystal controller. The liquid crystal module has a normal driving mode and a pause driving mode. When the liquid crystal controller receives an operation signal indicative of the normal driving mode or a pause signal indicative of the pause driving mode from the liquid crystal module, the liquid crystal controller transmits various signals necessary to control the liquid crystal module and image data to the liquid crystal module based on the received operation/pause signal, and refreshes a display image or stops refreshing.

Patent Documents 2 to 6 also describe display devices performing the pause driving. Concretely, Patent Document 2 discloses a microcomputer realizing lower power consumption while continuing operation of a predetermined peripheral circuit in a low power consumption mode. Patent Documents 3 and 4 disclose a method of driving a display device capable of realizing lower power consumption in a state where display qualities such as brightness and contrast are satisfied. Patent Document 5 discloses a display device realizing a reduction in power consumption by stopping a circuit consuming a large amount of power in a non-refresh period. Patent Document 6 discloses a drive device which does not cause unevenness of in-plane flicker when the operation in a non-display control period is stopped in an opposed inversion-drive-type liquid crystal display panel.

### PRIOR ART DOCUMENTS

### Patent Documents

[Patent Document 1] PCT International Publication No. WO 2010/010898

[Patent Document 2] Japanese Patent Application Laid-Open No. 2000-347762

[Patent Document 3] Japanese Patent Application Laid-Open No. 2001-278523

[Patent Document 4] Japanese Patent Application Laid-Open No. 2002-347762

[Patent Document 5] Japanese Patent Application Laid-Open No. 2004-78124

[Patent Document 6] Japanese Patent Application Laid-Open No. 2005-37685

### SUMMARY OF THE INVENTION

### Problems to be Solved by the Invention

However, for example, in the case of pause driving in which the screen is refreshed at 1 Hz, the refresh is performed only once in one second. Consequently, when an image is updated during the pause driving, there is a case such that the updated image is discarded and is not displayed. In this case, a viewer may feel strange on the displayed image.

Even when an image is updated during the pause driving, the liquid crystal display disclosed in any of the Patent Documents 1 to 6 cannot interrupt the pause driving and display the updated image. In this case as well, a viewer may feel strange on the displayed image.

Therefore, an object of the present invention is to provide a display device and a method of driving the same, capable of performing pause driving without making a viewer feel strange on a displayed image also in the case where the image is updated during the pause driving.

### Means for Solving the Problems

According to a first aspect of the present invention, there is provided a display device, including: a display unit including a plurality of pixel formation portions each having a switching element and a pixel capacitance connected to the switching element; a drive circuit that drives the display unit; and a display control circuit that controls the drive circuit based on image data transmitted from the outside, wherein the display control circuit includes an image detection circuit that detects updating of an image expressed by the image data, and when updating of the image expressed by the image data is detected during a pause driving performed in predetermined cycles such that a refresh period for refreshing a screen of the display unit and a non-refresh period for pausing refreshing of the screen appear at a predetermined rate, the image detection circuit interrupts the pause driving and forcedly refreshes the screen of the display unit.

According to a second aspect of the present invention, in the first aspect of the invention, the display control circuit further includes a timing control circuit having a counter that counts the number of times of the non-refresh periods, and when the number of times counted by the counter becomes a predetermined value, the timing control circuit refreshes the screen of the display unit by the image data.

According to a third aspect of the present invention, in the first aspect of the invention, the image detection circuit determines whether the image is updated or not based on information included in the image data and, when it is determined that the image is updated, outputs the image data to the drive circuit in the following frame period.

According to a fourth aspect of the present invention, in the first aspect of the invention, in the second aspect of the invention, the display control circuit further includes a rewritable frame memory which can hold the image data, the image detection circuit determines whether the image is an updated image or not based on information included in the image data, and writes the image data into the frame memory in a frame period in which the image data is received, and at the time of displaying the updated image in the display unit, the image data is read from the frame memory and transmitted to the drive circuit.

According to a fifth aspect of the present invention, in the fourth aspect of the invention, the image detection circuit determines that the image data is data of the updated image or not by comparing the image data with image data of a preceding frame stored in the frame memory.

According to a sixth aspect of the present invention, in the fourth aspect of the invention, the display control circuit further includes an interface unit which takes the image data and a timing control signal from data transmitted from the outside, the image data is written into the frame memory, and the timing control signal is supplied to a timing control circuit.

According to a seventh aspect of the present invention, in the sixth aspect of the invention, the display control circuit further includes a command register which outputs the image data as RAM write data based on a command transmitted from the outside, and the timing control circuit internally generates the timing control signal and outputs the generated timing control signal.

According to an eighth aspect of the present invention, in the fourth aspect of the invention, before the image data is written into the frame memory, image data held in the frame memory is read.

According to a ninth aspect of the present invention, in the first aspect of the invention, the display control circuit further includes a timing control circuit, the timing control circuit transmits a transmission request signal requesting transmission of data including the image data to an external electronic device, and the external electronic device transmits the data in sync with the transmission request signal.

According to a tenth aspect of the present invention, in the first aspect of the invention, the image detection circuit is a checksum circuit having a memory, and the checksum circuit checks whether the image data is the same as image data in a preceding frame or not by comparing a checksum value obtained by performing checksum operation on the image data with a checksum value stored in the memory.

According to an eleventh aspect of the present invention, in the first aspect of the invention, the image detection circuit determines whether the image data is data of an updated image or not based on image update information written into an image determination packet included in a header of the image data.

According to a twelfth aspect of the present invention, in the first aspect of the invention, the display control circuit further includes a command register which pre-stores image update information indicating whether the image data to be transmitted is data of an updated image or not, and each time the image data is received, the image detection circuit reads the image update information stored in the command register and determines whether the image data is data of the updated image or not.

According to a thirteenth aspect of the present invention, in the twelfth aspect of the invention, the image update information can be changed from the outside.

According to a fourteenth aspect of the present invention, in the first aspect of the invention, the pixel capacitance includes a pixel electrode connected to the switching element and an opposed electrode to which a common voltage is applied, the display control circuit further includes a common voltage generation circuit for generating the common voltage by inverting polarity of a voltage applied across the pixel electrode and the opposed electrode every predetermined cycle, and when the image detection circuit detects that the image data is updated, the common voltage generation circuit applies the common voltage of a polarity different from that when the updating of the image is detected across the opposed electrode and the pixel electrode, in the same period as a period since an immediately preceding scanning period until the image data is updated.

According to a fifteenth aspect of the present invention, in the fourteenth aspect of the invention, the display control circuit further includes a timing control circuit having a counter, and the timing control circuit counts, by the counter, a period since a most recent refresh until the image data is updated.

According to a sixteenth aspect of the present invention, in any one of the first to fourteenth aspect of the invention, the switching element is a thin film transistor having a control terminal connected to a scanning line formed in the display unit, a first conduction terminal connected to a signal line formed in the display unit, a second conduction terminal connected to a pixel electrode in the display unit so that a voltage according to an image to be displayed is applied, and a channel layer made by oxide semiconductor.

According to a seventeenth aspect of the present invention, there is provided a method of driving a display device, the display device comprising: a display unit including a plurality of pixel formation portions; a drive circuit that drives the display unit; and a display control circuit that controls the drive circuit based on image data transmitted from the outside, wherein the display control circuit includes an image detection circuit that detects updating of an image expressed by the image data, the method includes: a step, when updating of the image expressed by the image data transmitted from the outside is detected during a pause driving performed on the screen of the display unit such that a refresh period for refreshing the screen of the display unit and a non-refresh period for pausing refreshing of the screen appear at a predetermined rate, of interrupting the pause driving and forcedly refreshing the screen of the display unit.

According to an eighteenth aspect of the present invention, in the seventeenth aspect of the invention, the step of forcedly refreshing further comprises: a step of determining whether the image data is data of an updated image or not based on information included in the image data; and a step, when the image data is determined as data of the updated image, of outputting the image data to the drive circuit in the following frame period.

According to a nineteenth aspect of the present invention, in the seventeenth aspect of the invention, the display control circuit further includes a rewritable frame memory which can hold the image data, the method further comprising: a step of determining whether the image data is data of an updated image or not based on information included in the image data; a step, when the image data is determined as data of the updated image, of writing the image data into the frame memory in a frame period in which the image data is received; and a step, at the time of displaying an image in the display unit, of reading the image data from the frame memory and transmitting the read image data to the drive circuit.

### Effects of the Invention

According to the first aspect of the present invention, when updating of an image is detected by the image detection circuit provided for the display control circuit during a pause driving of the display device, the pause driving is interrupted, and the screen is forcedly refreshed. By the operation, even in the case where the image is updated during a predetermined cycle, while realizing lower power consumption, the pause driving which does not make the viewer feel strange on the displayed image can be performed.

According to the second aspect of the present invention, by counting the pause period by the counter provided for the timing control circuit, even image data is not updated, the image can be updated in predetermined cycles. Therefore, the display quality of the image in the pause period can be maintained high.

According to the third aspect of the present invention, a frame memory for writing image data is unnecessary. Therefore, the display device can be miniaturized and manufactured at low cost.

According to the fourth aspect of the present invention, the image data transmitted from the outside is held in the frame memory regardless of whether the image data is of an updated image or not. Consequently, the image data written into the frame memory can be always read and displayed, so that the pause driving can be performed effectively, and the quality of the image can be maintained high.

According to the fifth aspect of the present invention, whether an image is updated or not is determined by comparing input image data with image data in the frame memory. Consequently, determination of whether an image is an updated image or not can be performed easily and reliably.

According to the sixth aspect of the present invention, by using image data and timing control signal taken from data transmitted from the outside, the screen refresh timing and necessary image data can be controlled arbitrarily. Therefore, the pause driving can be realized effectively.

According to the seventh aspect of the present invention, using a command transmitted from the outside, image data is output as RAM write data, and a timing control signal is internally generated and output. Consequently, even when the timing control signal is not supplied from the outside, the display device can be driven. The pause driving can be realized effectively.

According to the eighth aspect of the present invention, data held in the frame memory is read first and then data is written into the frame memory, so that it can prevent a plurality of images from being displayed in one frame period. Since updated image data is always displayed in the following frame period, the image data is not discarded.

According to the ninth aspect of the present invention, when the timing control signal transmits a transmission request signal requesting transmission of data including the image data to an external electronic device, the external electronic device transmits, to the display device, data in sync with the transmission request signal. Thus, it can prevent tearing that images of a plurality of frames are displayed in one screen. The optimum pause driving adapted to the performance of the display device can be performed.

According to the tenth aspect of the present invention, a well-known checksum circuit can be used as the image detection circuit. Consequently, the determination of whether image data is updated image data or not can be performed easily and reliably.

According to the eleventh aspect of the present invention, the determination of whether image data is data of an updated image or not can be made easily and reliably based on image update information written into an image determination packet of a header of image data.

According to the twelfth aspect of the present invention, image update information indicating whether the image data to be transmitted is data of an updated image or not is pre-stored in the command register. Consequently, the determination of whether image data is data of an updated image or not can be made easily and reliably.

According to the thirteenth aspect of the present invention, the image update information can be changed from the outside, so that the image update information can be easily changed.

According to the fourteenth aspect of the present invention, when updated image data is supplied and the forced refresh is performed during the counter-refresh driving or the pause driving, before the refresh driving and the pause driving are repeated again in predetermined cycles, an adjustment period is provided such that the periods of inverting the polarity of a voltage applied across the opposed electrode and the pixel electrode before and after performing the forced refresh become equal to each other. Consequently, a problem such as flicker in an image displayed is solved, and display quality can be improved.

According to the fifteenth aspect of the present invention, the period since a most recent refresh until the data is updated is counted by the counter of the timing control circuit. Thus, the counting can be performed easily and reliably.

According to the sixteenth aspect of the present invention, the channel layer of the thin film transistor provided for the pixel formation portion is made by oxide semiconductor. Therefore, the off-leakage current of the thin film transistor is largely reduced, and the voltage written in the pixel capacitance is held for longer period of time.

According to the seventeenth aspect of the present invention, an effect similar to that of the first aspect can be produced.

According to the eighteenth aspect of the present invention, an effect similar to that of the third aspect can be produced.

According to the nineteenth aspect of the present invention, an effect similar to that of the fourth aspect can be produced.

### BRIEF DESCRIPTION OF THE DRAWINGS

FIG. 1 is a block diagram illustrating a configuration of an active matrix-type liquid crystal display device according to a first embodiment of the present invention.

FIG. 2 is a block diagram illustrating a configuration of a display control circuit included in the liquid crystal display device according to the first embodiment of the present invention.

FIG. 3 is a diagram illustrating counter refresh performed by a display control device included in the liquid crystal display device according to the first embodiment of the present invention.

FIG. 4 is a diagram illustrating forced refresh performed by the display control device included in the liquid crystal display device according to the first embodiment of the present invention.

FIG. 5 is a timing chart illustrating operation of the liquid crystal display device according to the first embodiment of the present invention.

FIG. 6 is a block diagram illustrating a configuration of a display control circuit included in a liquid crystal display device according to a modification of the first embodiment of the present invention.

FIG. 7 is a block diagram illustrating a configuration of a display control circuit included in a liquid crystal display device according to a second embodiment of the present invention.

FIG. 8 is a diagram illustrating counter refresh performed by a display control circuit of an RAM capture type included in the liquid crystal display device according to a second embodiment of the present invention.

FIG. 9 is a diagram illustrating forced refresh performed by the display control circuit of the RAM capture type included in the liquid crystal display device according to the second embodiment of the present invention.

FIG. 10 is a timing chart illustrating operation of the liquid crystal display device according to the second embodiment of the present invention.

FIG. 11 is a block diagram illustrating a configuration of a display control circuit included in a liquid crystal display device according to a modification of the second embodiment of the present invention.

FIG. 12 is a block diagram illustrating a configuration of a display control circuit included in a liquid crystal display device according to a third embodiment of the present invention.

FIG. 13 is a timing chart illustrating operation of the liquid crystal display device according to the third embodiment of the present invention.

FIG. 14 is a block diagram illustrating a configuration of a display control circuit included in a liquid crystal display device according to a modification of the third embodiment of the present invention.

FIGS. 15(a), 15(b), and 15(c) are diagrams illustrating polarities of voltages applied across a pixel electrode and an opposed electrode in frame periods at the time of AC driving the liquid crystal display devices according to the embodiments of the present invention, more specifically, FIG. 15(a) is a diagram illustrating polarities of voltages applied across a pixel electrode and an opposed electrode in the frame periods at the time of counter refresh, FIG. 15(b) is a diagram illustrating polarities of voltages applied across the pixel electrode and the opposed electrode in the frame periods when an adjustment period is not provided after performing forced refresh, and FIG. 15(c) is a diagram illustrating polarities of voltages applied across the pixel electrode and the opposed electrode in the frame periods when an adjustment period is provided after performing forced refresh.

FIG. 16 is a block diagram illustrating a configuration of a display control circuit using a header of image data included in a liquid crystal display device according to a modification of each of the embodiments of the present invention.

FIG. 17 is a block diagram illustrating a configuration of a display control circuit capable of presetting a frame in which an image is updated, included in a liquid crystal display device according to a modification of each of the embodiments of the present invention.

### MODES FOR CARRYING OUT THE INVENTION

In recent years, multimedia compatibility has been developed in portable terminals, and the data transfer rate among a processor, a camera, a display, and the like has been rapidly improved. To address such a situation, in portable terminals, a high-speed serial interface standard called the MIPI-DSI (Display Serial Interface) standard planned by the MIPI (Mobile Industry Processor Interface) alliance is attracting attention. Since the MIPI-DSI standard is a standard adapted to data transfer of a few Gbps and many architecture options are prepared, it is expected that the standard dramatically increases the performance of a next-generation portable terminal.

As a liquid crystal display device according to each of embodiments of the present invention, description will be given of a display device which is driven based on a command of the MIPI-DSI standard and used mainly for a portable terminal. The display device of the present invention, however, is not limited to the liquid crystal display device used for a portable terminal, but is widely and effectively used for displaying images while combining an image having little change such as a still image and an image having a large change such as a moving image in chronological order in a liquid crystal display device which is pause-driven.

In the specification, a configuration of a display control circuit included in a liquid crystal display device to be described later will be descried in three modes. A first mode is a mode of using a video mode and providing no RAM (Random Access Memory). In the following, such a first mode will be called “video-mode RAM through”. A second mode is a mode of using a video mode and providing an RAM. In the following, such a second mode will be called “video-mode RAM capture”. A third mode is a mode of using a command mode and providing an RAM. In the following, such a third mode will be called “command-mode RAM writing”. The details of the three modes will be described in detail in the following embodiments.

### 1. First Embodiment

### 1.1 Configuration of Liquid Crystal Display Device

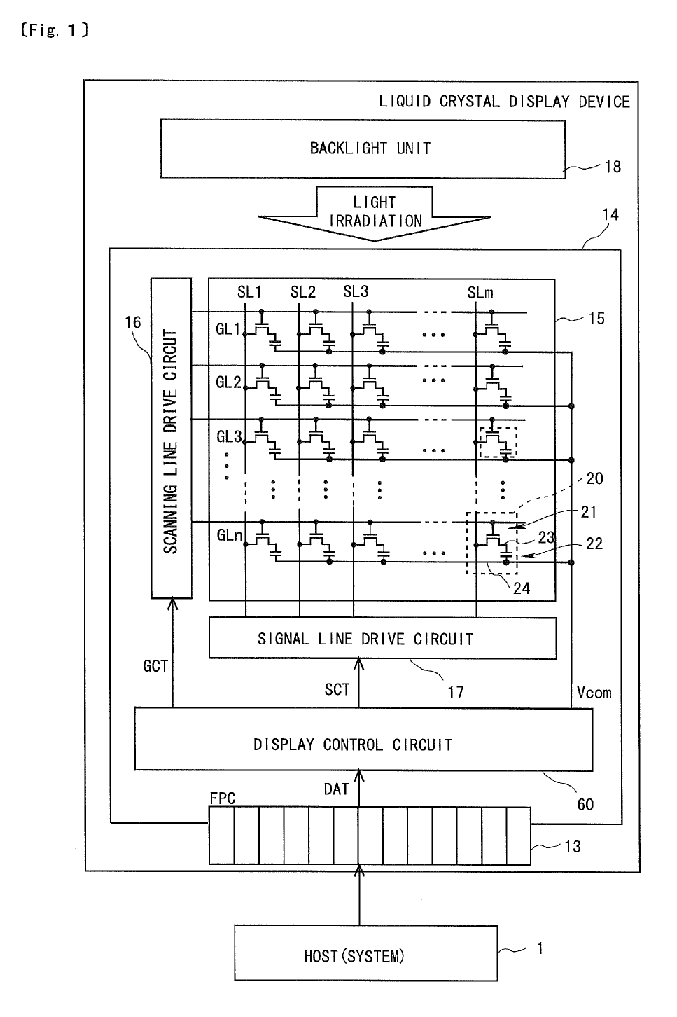

FIG. 1 is a block diagram illustrating a configuration of a liquid crystal display device according to a first embodiment of the present invention. As illustrated in FIG. 1, the liquid crystal display device has a liquid crystal display panel 14 and a backlight unit 18. The liquid crystal display panel 14 is provided with an FPC (Flexible Printed Circuit) 13 to be connected to an external electronic device. In addition, the liquid crystal display panel 14 has thereon a display unit 15, a display control circuit 60, a signal line drive circuit 17, and a scanning line drive circuit 16. The scanning line drive circuit 16 and/or the signal line drive circuit 17 may be provided in the display control circuit 60. The scanning line drive circuit 16 and/or the signal line drive circuit 17 may be formed integrally with the display unit 15. On the outside of the liquid crystal display device, a host (system) 1 mainly including a CPU is provided. The scanning line drive circuit 16 and the signal line drive circuit 17 will sometimes be collectively called a drive circuit.

In the display unit 15, there are formed a plurality (m pieces) of signal lines SL1 to SLm, a plurality (n pieces) of scanning lines GL1 to GLn, and a plurality (m×n pieces) of pixel formation portions 20 provided at the respective intersections of the m pieces of signal lines SL1 to SLm and the n pieces of scanning lines GL1 to GLn. Hereinafter, in the case where the m pieces of the signal lines SL1 to SLm are not distinguished from one another, they will be simply called the “signal lines SL”, and in the case where the n pieces of scanning lines GL1 to GLn are not distinguished from one another, they will be simply called the “scanning lines GL”. The m×n pieces of pixel formation portions 20 are formed in a matrix form. Each of the pixel formation portions 20 includes: a TFT (switching element) 21 whose gate terminal as a control terminal is connected to the scanning line GL passing through a corresponding intersection and whose source terminal as a first conduction terminal is connected to the signal line SL passing through the intersection; a pixel electrode 23 connected to the drain terminal as a second conduction terminal of the TFT 21; an opposed electrode 24 commonly provided for the m×n pieces of pixel formation portions 20; and a liquid crystal layer (not illustrated) sandwiched between the pixel electrode 23 and the opposed electrode 24 and provided commonly for the plurality of pixel formation portions 20. A liquid crystal capacitance formed by the pixel electrode 23, the opposed electrode 24, and the liquid crystal layer serves as a pixel capacitance 22. Typically, in many cases, an auxiliary capacitance is provided in parallel to the liquid crystal capacitance in order to reliably maintain voltage in the pixel capacitance 22. In this case, the pixel capacitance 22 is constituted by the liquid crystal capacitance and the auxiliary capacitance.

In the present embodiment, as the TFT 21, for example, a TFT using oxide semiconductor for a channel layer (hereinbelow, called an “oxide TFT”) is used. More specifically, the channel layer of the TFT 21 is formed by IGZO (InGaZnOx) whose main components are indium (In), gallium (Ga), zinc (Zn), and oxygen (O). In the following, a TFT using IGZO for the channel layer will be called an “IGZO-TFT”. In the IGZO-TFT, off-leakage current is largely reduced as compared with that in a silicon-based TFT using amorphous silicon or the like for the channel layer. Consequently, the voltage written in the pixel capacitance 22 can be held for longer period. A similar effect is obtained also in the case of using, as an oxide semiconductor other than IGZO, an oxide semiconductor containing at least one of indium, gallium, zinc, copper (Cu), silicon (Si), tin (Sn), aluminum (Al), calcium (Ca), germanium (Ge), and lead (Pb) for the channel layer. In place of using the oxide semiconductor for the channel layer in the TFT 21, polycrystal silicon may be used.

The display control circuit 60 is typically realized as an IC (Integrated Circuit). The display control circuit 60 receives data DAT from the host 1 via the FPC 13 and, according to it, generates and outputs a signal line control signal SCT, a scanning line control signal GCT, and a common voltage Vcom. The signal line control signal SCT is given to the signal line drive circuit 17. The scanning line control signal GCT is given to the scanning line drive circuit 16. The common voltage Vcom is given to the opposed electrode 24. In the present embodiment, transmission/reception of the data DAT between the host 1 and the display control circuit 60 is performed via an interface conformed to the MIPI-DSI standard. By the interface conformed to the DSI standard, high-speed data transmission can be performed. In the present embodiment, a video mode of the interface conformed to the DSI standard is used.

The signal line drive circuit 17 generates and outputs a drive image signal to be given to the signal line SL in accordance with the signal line control signal SCT. The signal line control signals SCT include, for example, a digital image signal corresponding to RGB data RGBD, a source start pulse signal, a source clock signal, a latch strobe signal, and the like. The signal line drive circuit 17 generates a drive image signal by making a shift register, a sampling latch circuit, and the like (which are not illustrated) which are provided therein operate in accordance with the source start pulse signal, the source clock signal, and the latch strobe signal and by converting a digital signal obtained based on a digital image signal to an analog signal by a DA conversion circuit (not illustrated).

The scanning line drive circuit 16 repeats application of an active scanning signal to the scanning lines GL at predetermined intervals in accordance with the scanning line control signal GCT. The scanning line control signal GCT includes, for example, a gate clock signal and a gate start pulse signal. The scanning line drive circuit 16 operates the shift register and the like (which are not illustrated) which are provided therein in accordance with the gate clock signal and the gate start pulse signal to generate a scanning signal.

The backlight unit 18 is provided on the back side of the liquid crystal display panel 14 and illuminates the back side of the liquid crystal display panel 14 with backlight. The backlight unit 18 typically includes a plurality of LEDs (Light Emitting Diodes). The backlight unit 18 may be controlled by the display control circuit 60 or may be controlled by another method. The backlight unit 18 may include a plurality of cold cathode-ray tubes in place of the plurality of LEDs. In the case where the liquid crystal display panel 14 is of a reflection type, it is unnecessary to provide the backlight unit 18.

When the drive image signal is applied to the signal lines SL, the scanning signal is applied to the scanning line GL, and the backlight unit 18 is driven as described above, a screen according to the image data transmitted from the host 1 is displayed in the display unit 15 of the liquid crystal display panel 14.

### 1.2 Video-Mode RAM Through

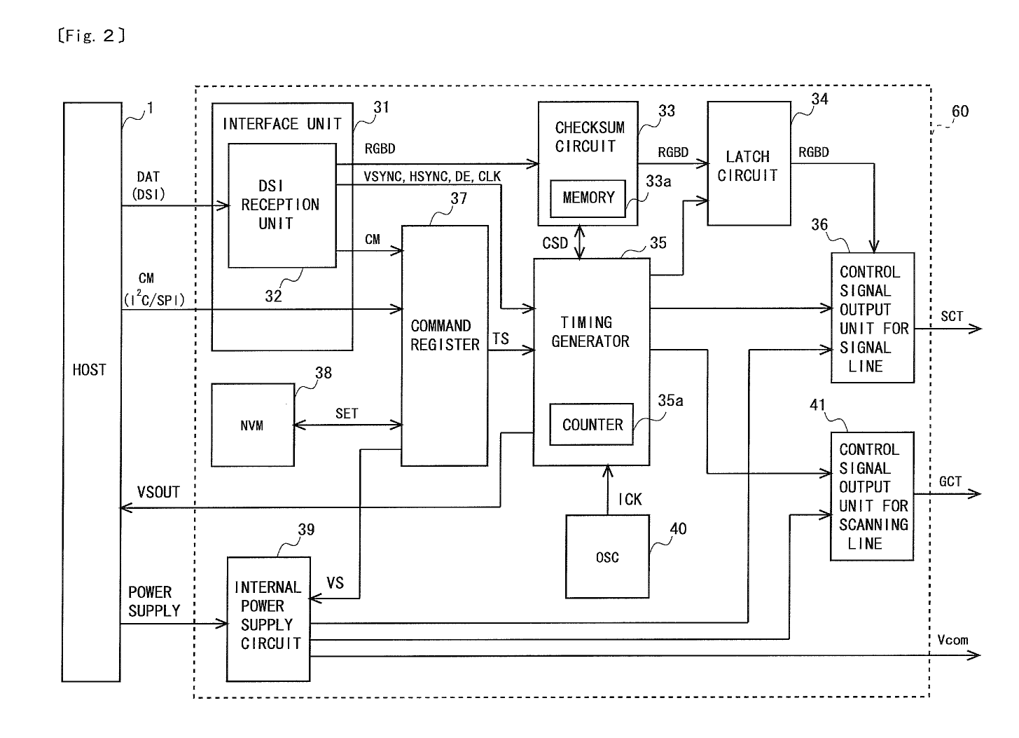

FIG. 2 is a block diagram illustrating a configuration of a display control circuit 60 adapted to video-mode RAM through (hereinbelow, called “display control circuit 60 of video-mode RAM through) in the present embodiment. As illustrated in FIG. 2, the display control circuit 60 has an interface unit 31, a command register 37, an NVM (Non-Volatile Memory) 38, a timing generator 35, an OSC (Oscillator) 40, a checksum circuit 33, a latch circuit 34, an internal power supply circuit 39, a control signal output unit for signal line 36, and a control signal output unit for scanning line 41. The interface unit 31 includes a DSI reception unit 32, the checksum circuit 33 includes a memory 33a, and the timing generator 35 includes a counter 35a. As described above, the scanning line drive circuit 16 and/or the signal line drive circuit 17 may be provided in the display control circuit 60. Here, the timing generator 35 is also called a timing control circuit.

The DSI reception unit 32 in the interface unit 31 is conformed to the DSI standard. The data DAT in the video mode includes RGB data RGBD indicative of data of an image, a vertical sync signal VSYNC, a horizontal sync signal HSYNC, a data enable signal DE, and a clock signal CLK which are sync signals, and command data CM. The command data CM includes data on various controls. When the DSI reception unit 32 receives the data DAT from the host 1, the DSI reception unit 32 transmits the RGB data RGBD included in the data DAT to the checksum circuit 33, transmits the vertical sync signal VSYNC, the horizontal sync signal HSYNC, the data enable signal DE, and the clock signal CLK to the timing generator 35, and transmits the command data CM to the command register 37. The command data CM may be transmitted from the host 1 to the command register 37 via an interface conformed to the I2C (Inter Integrated Circuit) standard or the SPI (Serial Peripheral Interface) standard. In this case, the interface unit 31 includes a reception unit conformed to the I2C standard or the SPI standard. The signals such as the vertical sync signal VSYNC, the horizontal sync signal HSYNC, and the data enable signal DE are also called timing control signals TS.

The checksum circuit 33 can obtain a checksum value by performing an arithmetic operation (checksum) each time the RGB data RGBD of one screen is received and store the obtained checksum value into the memory 33a. A checksum value is obtained on the RGB data RGBD of a frame, and the obtained checksum value is stored into the memory 33a. Subsequently, checksum is performed on the RGB data RGBD of the immediately subsequent frame. The obtained checksum value and the checksum value stored in the memory 33a are compared. When they are the same, it is determined that the images are the same. When they are different from each other, it is determined that the images are different from each other. Then, the result is transmitted as checksum process data CSD to the timing generator 35. The reason why the checksum circuit 33 is used as described above is because determination of whether the RGB data RGBD is updated data or not can be made easily and reliably.

In the following description, the checksum value is a value obtained by performing checksum on image data of one screen and is obtained one by one for each frame. However, it is also possible to obtain a checksum value of, for example, a line or a block. In this case, a checksum value of a certain part in one screen is obtained. A checksum value may be obtained line by line or block by block. In this case, as checksum values of one screen, a plurality of values are obtained.

The command register 37 holds the command data CM. In the NVM 38, setting data SET for various controls is held. The command register 37 reads the setting data SET held in the NVM 38, and updates the setting data SET in accordance with the command data CM. The command register 37 transmits the timing control signal TS to the timing generator 35 in accordance with the command data CM and the setting data SET, and transmits a voltage setting signal VS to the internal power supply circuit 39.

The timing generator 35 receives the checksum process data CSD from the checksum circuit 33. When it is determined that an image is not updated based on the checksum process data CSD, the timing generator 35 increments the count value of the counter 35a and, when the count value becomes a predetermined value (counter set value), refreshes the screen for continuously displaying the same image. On the other hand, when it is determined that the image is updated, the timing generator 35 refreshes the screen to display the updated image.

The timing generator 35 generates and transmits control signals for controlling the latch circuit 34, the control signal output unit for signal line 36, and the control signal output unit for scanning line 41 based on the vertical sync signal VSYNC, the horizontal sync signal HSYNC, the data enable signal DE, the clock signal CLK, the timing control signal TS, and an internal clock signal ICK generated by the OSC 40. The timing generator 35 transmits, to the host 1, the vertical sync output signal VSOUT generated based on the vertical sync signal VSYNC, the horizontal sync signal HSYNC, the data enable signal DE, the clock signal CLK, the timing control signal TS, and the internal clock signal ICK generated by the OSC 40. The host 1 transmits the data DAT to the DSI reception unit 32 in sync with the vertical sync output signal VSOUT. The vertical sync output signal VSOUT is a signal for controlling a transmission timing of the data DAT from the host 1 so that the write timing of the RGB data RGBD to the frame memory 51 and the read timing from the frame memory 51 do not synchronize. However, since the display control circuit 60 of the present embodiment is not provided with a frame memory, tearing that images of a plurality of frames are displayed in one screen does not occur. Consequently, in the display control circuit 60 of the video-mode RAM through, the vertical sync output signal VSOUT is not an essential signal and the OSC 40 is not also an essential component. The vertical sync output signal VSOUT will be also called a transmission request signal.

The latch circuit 34 transmits the RGB data RGBD of one line to the control signal output unit for signal line 36 based on the control of the timing generator 35. The internal power supply circuit 39 generates and outputs a power supply voltage and the common voltage Vcom to be used in the control signal output unit for signal line 36 and the control signal output unit for scanning line 41 based on the power given from the host 1 and the voltage setting signal VS given from the command register 37.

The control signal output unit for signal line 36 generates a signal line control signal SCT based on the RGB data RGBD from the latch circuit 34, the control signal from the timing generator 35, and the power supply voltage from the internal power supply circuit 39 and transmits the signal line control signal SCT to the signal line drive circuit 17.

The control signal output unit for scanning line 41 generates a scanning line control signal GCT based on the control signal from the timing generator 35 and the power supply voltage from the internal power supply circuit 39 and transmits the scanning line control signal GCT to the scanning line drive circuit 16.

At the time of pause driving, to reduce power consumption, the operation of the internal circuits such as the latch circuit 34, the control signal output unit for signal line 36, and the control signal output unit for scanning line 41 is stopped. Consequently, when the liquid crystal display device is pause-driven, the same image is continuously displayed.

As described above, in the display control circuit 60 of the video-mode RAM through, a frame memory is not provided between the checksum circuit 33 and the latch circuit 34. Consequently, as described later, the forced refresh is performed not in a frame period in which the RGB data is updated but in the following frame period.

When the number of frames is counted by the counter 35a provided in the timing generator 35 and the count value of the counter 35a becomes a predetermined value (counter set value), even though RGB data is not updated, the image displayed in the display unit 15 is updated by the counter refresh.

### 1.3 Refresh Operation

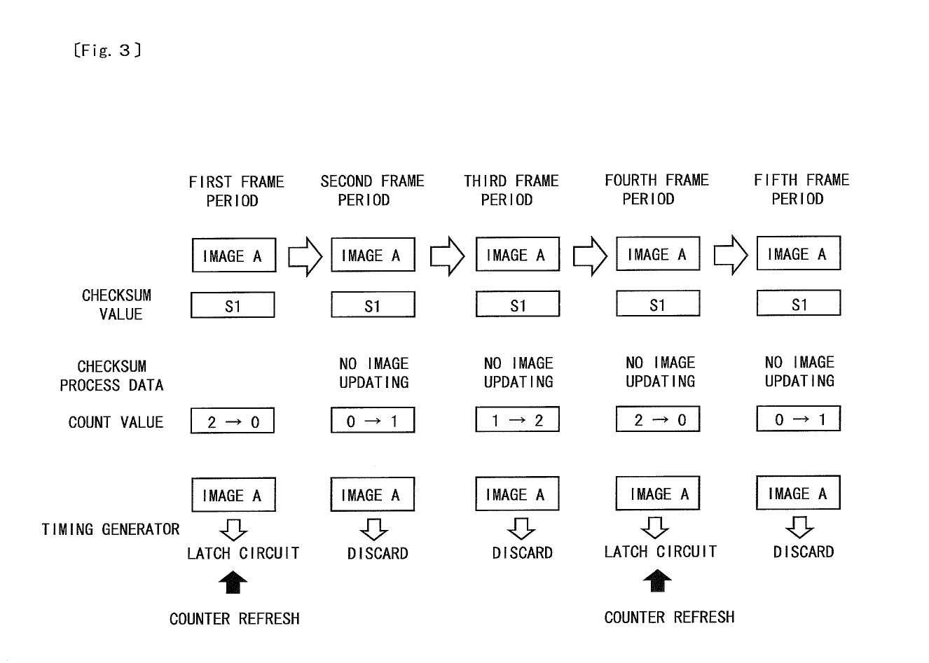

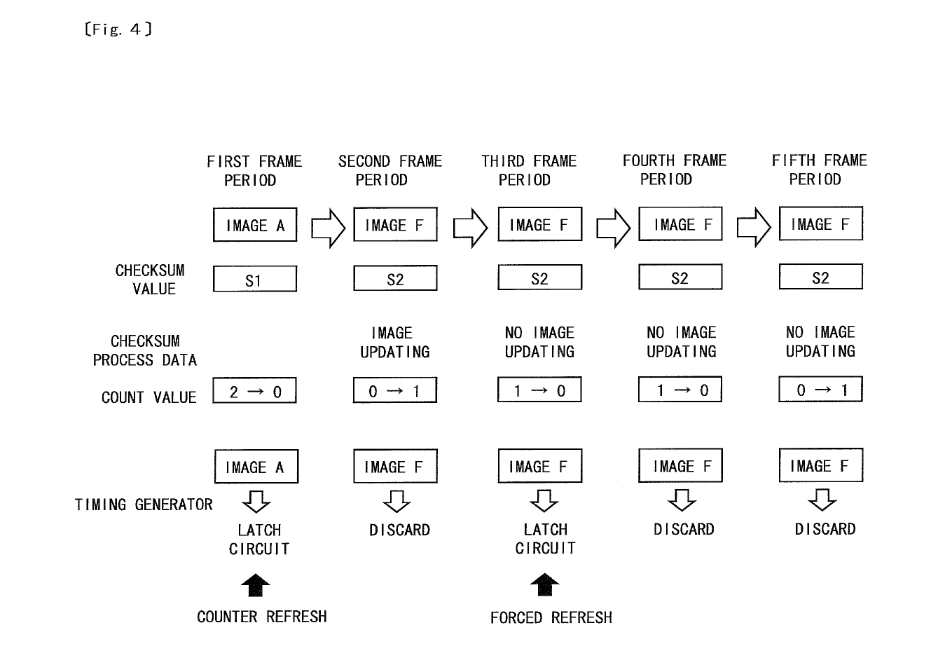

Description will be given of the operation of the display control circuit 60 included in the liquid crystal display device of the present embodiment. FIG. 3 is a diagram illustrating the operation of the display control circuit 60 in the case of refreshing (counter-refreshing) an image displayed in the display unit 15 every predetermined cycle. FIG. 4 is a diagram illustrating the operation of the display control circuit 60 in the case of refreshing (forced-refreshing) an image displayed in the display unit 15 during a predetermined cycle.

With reference to FIG. 3, the operation of the display control circuit 60 in the case of updating the screen by the counter refresh even when an image is not updated will be described. In the specification, it is assumed that the counter refresh is performed when the count value of the counter 35a provided in the timing generator 35 becomes 2.

In a first frame period, the count value of the counter 35a becomes 2 as the count set value, so that the checksum circuit 33 outputs RGB data to the latch circuit 34 while obtaining a checksum value S1 of the received RGB data. By the operation, an image A is refreshed. At this time, the checksum circuit 33 stores the obtained checksum value S1 into the memory 33a. The timing generator 35 resets the count value of the counter 35a.

In a second frame period, since the count value of the counter 35a is 0, the counter refresh is not performed. The checksum circuit 33 obtains the checksum value of the received RGB data. Since the obtained checksum value S1 is the same as the checksum value S1 stored in the memory 33a, it is determined that the image has not been updated. The checksum circuit 33 updates the checksum value S1 stored in the memory 33a with the obtained checksum value S1 and discards the RGB data. The timing generator 35 sets the count value of the counter 35a to 1 and performs pause driving.

In a third frame period, the count value of the counter 35a is 1, and the checksum value of the RGB data is S1. Consequently, in a manner similar to the case of the second frame period, the checksum circuit 33 overwrites the checksum value S1 stored in the memory 33a and discards the RGB data. The timing generator 35 sets the count value of the counter 35a to 2, and performs pause driving.

In a fourth frame period, the checksum value of the received RGB data is obtained. Since the obtained checksum value S1 is the same value as the checksum value S1 of the third frame period, it is determined that the image is not updated. However, the count value of the counter 35a becomes a count set value of 2. The checksum circuit 33 outputs the RGB data to the latch circuit 34 to perform the counter refresh. Consequently, the image A is counter-refreshed. At this time, the checksum circuit 33 overwrites the checksum value S1 stored in the memory 33a with the obtained checksum value S1. The timing generator 35 resets the count value of the counter 35a.

In a fifth frame period, like in the second frame period, the checksum value is S1, and the count value of the counter 35a is 0. The checksum circuit 33 overwrites the checksum value S1 stored in the memory 33a with the obtained checksum value S1, and discards the RGB data. The timing generator 35 sets the count value of the counter 35a to 1 and performs pause driving.

Hereinafter, in a manner similar to the above, in the case of continuously displaying the image A, the liquid crystal display device repeats the counter refresh once after performing the pause driving in two frame periods.

Next, the case where an image is updated during a predetermined cycle will be described. In this case, forced refresh has to be performed to make the image displayed until now an updated image. With reference to FIG. 4, description will be given of the operation of the display control circuit 60 in the case of updating the image by the forced refresh.

In the first frame period, in a manner similar to the case of the first frame period illustrated in FIG. 3, the counter refresh is performed, and thus its description will not be repeated.

In the second frame period, the count value of the counter 35a is 0, and it is not timing of performing the counter refresh. However, the checksum value obtained by the checksum circuit 33 is S2 which is different from the checksum value S1 stored in the memory 33a. Consequently, the checksum circuit 33 detects that the image is updated from the image A to an image F, rewrites the checksum value S1 stored in the memory 33a with the obtained checksum value S2, and discards the RGB data of the frame. Checksum process data CSD indicating that the image is updated is transmitted to the timing generator 35. The timing generator 35 sets the count value to 1 and performs the pause driving.

In the third frame period, the count value of the counter 35a is 1. However, the timing generator 35 detects that the image is updated in the second frame period from the checksum process data CSD received in the second frame period. Therefore, even when the count value is smaller than the count set value of 2, the RGB data of the checksum circuit 33 is output to the latch circuit 34. The screen is consequently forced refreshed, and the image A is changed to the image F. At this time, the checksum circuit 33 overwrites the checksum value S2 stored in the memory 33a with the obtained checksum value S2, and the timing generator 35 resets the count value.

In the fourth frame period, the checksum value S2 of the RGB data obtained by the checksum circuit 33 is the same as the checksum value S2 stored in the memory 33a, and thus an image F is not updated. Since the count value of the counter 35a is 1, it is not timing of performing the counter refresh. The checksum circuit 33 overwrites the checksum value S2 stored in the memory 33a with the obtained checksum value S2, and discards the RGB data of the frame. The timing generator 35 sets the count value to 1 and performs the pause driving.

In the fifth frame period, like in the case of the fourth frame period, the checksum value S2 stored in the memory 33a is overwritten with the checksum value S2 of the RGB data obtained by the checksum circuit 33, and the RGB data of the frame is discarded. The timing generator 35 sets the count value to 2, and performs the pause driving.

In such a manner, in the case of continuously displaying the image A, the liquid crystal display device repeats an operation of performing the counter refresh once after the pause driving is performed in two frame periods. When the image A is updated to the image F during the pause driving, however, the pause driving is stopped even during the pause driving, and the image A displayed in the display unit 15 is forced-refreshed to the updated image F.

### 1.4 Timing Chart

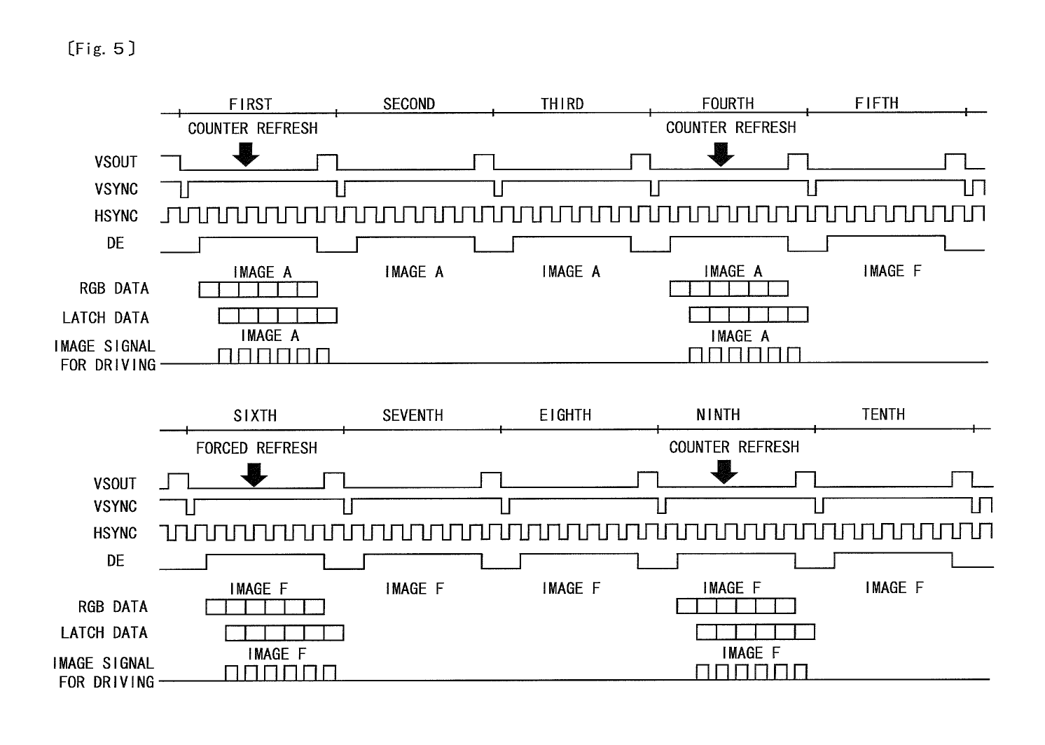

FIG. 5 is a timing chart illustrating the operation of the liquid crystal display device according to the present embodiment. FIG. 5 illustrates, in order from the above, a vertical sync output signal VSOUT, the vertical sync signal VSYNC, the horizontal sync signal HSYNC, the data enable signal DE, the RGB data, the data of the latch circuit 34, and an image signal for driving. Note that in FIG. 5, the vertical sync signal VSYNC and the horizontal sync signal HSYNC are signals of negative logic.

In the first frame period illustrated in FIG. 5, the vertical sync output signal VSOUT is transmitted from the timing generator 35 to the host 1. The host 1 receives the vertical sync output signal VSOUT and transmits a control signal such as the vertical sync signal VSYNC to the liquid crystal display device in sync with the rising edge of the vertical sync output signal VSOUT. In sync with the falling edge of the horizontal sync signal HSYNC, the data enable signal DE indicative of the range of valid RGB data rises from the L level to the H level, and the RGB data of the image A is given to the checksum circuit 33 during a period in which the data enable signal DE is at the H level. In the following, the description of the vertical sync output signal VSOUT will not be repeated.

Since the count value of the counter 35a is 2 as the count set value at this time, the counter refresh is performed. Concretely, the RGB data whose checksum value is obtained by the checksum circuit 33 is transmitted to the latch circuit 34. In such a manner, the screen is counter-refreshed with the image A.

In the second frame period, the count value of the counter 35a is 0, so that the counter refresh is not performed. Since the checksum circuit 33 receives the RGB data of the image A which is the same as that in the first frame period, the checksum value obtained by the checksum circuit 33 matches the checksum value stored in the memory 33a. At the same time, the checksum circuit 33 discards the RGB data of the image A without giving it to the latch circuit 34. Consequently, the liquid crystal display device performs the pause driving, and the screen is not refreshed.

Also in the third frame period, neither the counter refresh nor the forced refresh is not performed, and the liquid crystal display device continues the pause driving.

In the fourth frame period, the count value of the counter 35a becomes 2 as the counter set value, so that the counter refresh is performed. When the RGB data of the image A is supplied to the checksum circuit 33 in accordance with the data enable signal DE, the checksum circuit 33 obtains the checksum value of the image A. The RGB data whose checksum value is obtained is supplied to the latch circuit 34. Consequently, in a manner similar to the case of the first frame period, the screen is counter-refreshed with the image A.

In the fifth frame period, the count value of the counter 35a is 0. However, the checksum value obtained by the checksum circuit 33 is different from the checksum value stored in the memory 33a. Consequently, it is determined that the RGB data given to the checksum circuit 33 is the data of the image F different from the image A which is supplied in the fourth frame period, and the checksum value stored in the memory 33a is rewritten with the obtained checksum value. However, the RGB data of the image F of the frame is discarded without being given to the latch circuit 34. Consequently, in the fifth frame period, the forced refresh is not performed, and the liquid crystal display device performs the pause driving of displaying the image A. At this time, the updating of the image A with the image F is transmitted to the timing generator 35.

In the sixth frame period, the count value of the counter 35a is 1, and the counter refresh is not performed. However, the timing generator 35 detects that the image is updated from the image A to the image F in the fifth frame period. The timing generator 35 outputs a control signal to the latch circuit 34 and the like to perform the forced refresh. Consequently, with the RGB data of the image F transmitted to the latch circuit 34 in the sixth frame period, the forced refresh is performed to update the image A displayed in the screen to the image F. When the forced refresh is performed, the counter 35a is reset.

In the seventh and eighth frame periods, the checksum circuit 33 obtains the checksum value of the image F and discards the image F. Consequently, neither the counter refresh nor the forced refresh is performed, and the liquid crystal display device performs the pause driving.

In the ninth frame period, the count value of the counter 35a becomes 2 as the counter set value for performing a refresh. Therefore, in a manner similar to the case of the fourth frame period, the screen is counter-refreshed with the image F.

In the tenth frame period, the count value of the counter 35a is 0, so that the counter refresh is not performed. Since the checksum value is the same as the checksum value stored in the memory 33a, the forced refresh is not also performed. Therefore, in a manner similar to the case of the seventh frame period, the RGB data is discarded without being given to the latch circuit 34, and the liquid crystal display device performs the pause driving.

### 1.5 Effects

By the checksum circuit 33 provided for the display control circuit 60 of the display device, whether the given image data is updated data or not is determined based on a checksum value extracted from each frame. When it is determined that the given image data is updated image data even in the pause driving, the pause driving is interrupted, the updated image data is immediately output to the signal line drive circuit 17, and the forced refresh is immediately performed. Consequently, while realizing a reduction in power consumption, the pause driving can be performed in which a viewer does not feel strangeness on a displayed image.

By counting the pause period by the counter 35a provided for the timing generator 35, the image can be updated by predetermined intervals even when the image data is not updated. Consequently, the display quality of the image can be maintained high.

The liquid crystal display device according to the present embodiment does not need a frame memory for writing the RGB data RGBD. Therefore, the liquid crystal display device is miniaturized and manufactured at low price.

### 1.6 Modification

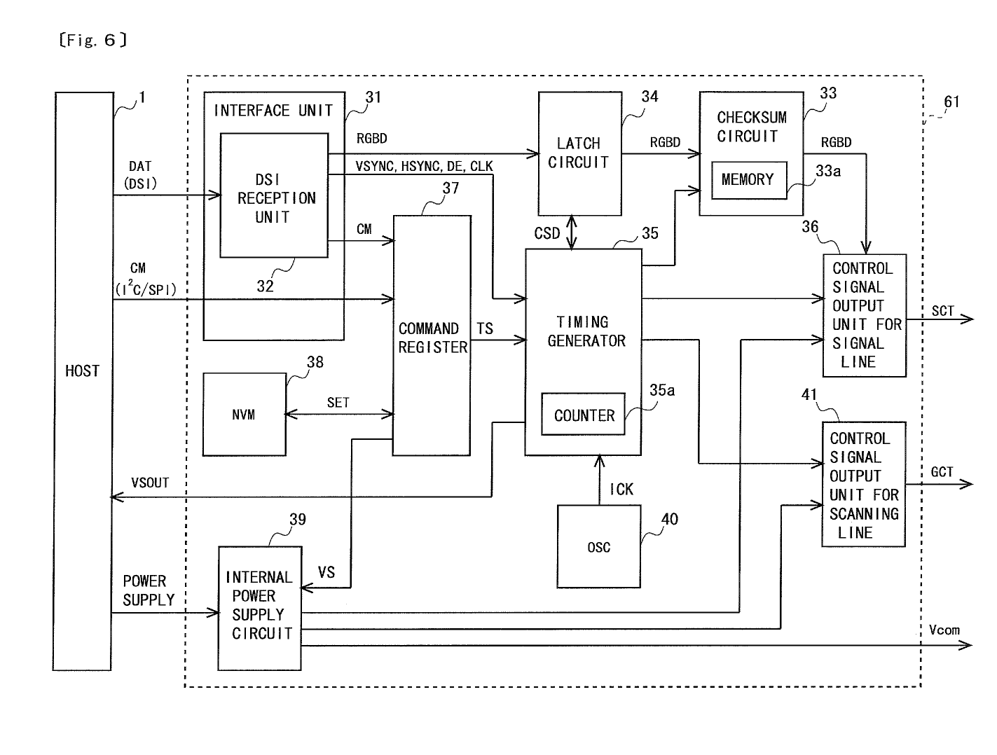

FIG. 6 is a block diagram illustrating the configuration of a display control circuit 61 included in a liquid crystal display device according to a modification of the present embodiment. In FIG. 6, the same reference numerals are designated to the same components as those illustrated in FIG. 2 throughout this description.

In the display control circuit 60 illustrated in FIG. 2, the checksum circuit 33 is provided between the interface unit 31 and the latch circuit 34, and the RGB data whose checksum value is obtained by the checksum circuit 33 is transmitted to the latch circuit 34. However, the position in which the checksum circuit 33 is provided is not limited to the above and, as illustrated in FIG. 6, the checksum circuit 33 may be provided between the latch circuit 34 and the control signal output unit for signal line 36. Also in the case of providing the checksum circuit 33 between the latch circuit 34 and the control signal output unit for signal line 36 as described above, effects similar to those of the liquid crystal display device according to the present embodiment are produced.

### 2. Second Embodiment

Since a configuration of an active matrix-type liquid crystal display device according to a second embodiment of the present invention is the same as that of the active matrix-type liquid crystal display device according to the first embodiment illustrated in FIG. 1, a block diagram illustrating the configuration of the liquid crystal display device and description of the device will not be repeated.

### 2.1 Video-Mode RAM Capture

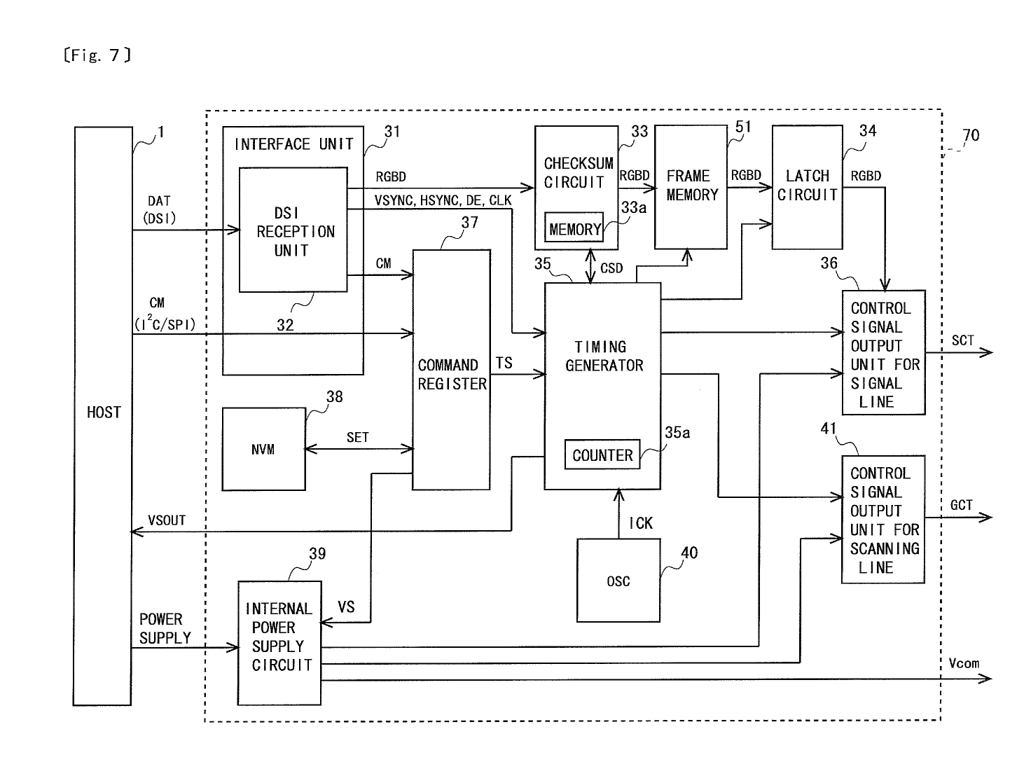

FIG. 7 is a block diagram illustrating the configuration of a display control circuit 70 corresponding to the video-mode RAM capture (hereinbelow, called “display control circuit 70 of video-mode RAM capture”) in the present embodiment. The display control circuit 70 has, like the display control circuit 60 of the first embodiment, the interface unit 31 including the DSI reception unit 32, the checksum circuit 33, the latch circuit 34, the timing generator 35, the command register 37, the OSC 40, the control signal output unit for signal line 36, the control signal output unit for scanning line 41, the NVM 38, and the internal power supply circuit 39 and, further, has a frame memory 51 between the checksum circuit 33 and the latch circuit 34.

In the display control circuit 60 of the video-mode RAM through, the RGB data RGBD is directly transmitted from the checksum circuit 33 to the latch circuit 34. In the display control circuit 70 of the video-mode RAM capture, the RGB data RGBD transmitted from the checksum circuit 33 is written into the frame memory 51. The RGB data RGBD written into the frame memory 51 is read by the latch circuit 34 in accordance with the control signal generated by the timing generator 35.

The timing generator 35 transmits the vertical sync output signal VSOUT to the host 1. The vertical sync output signal VSOUT is a signal for controlling a transmission timing of the data DAT from the host 1 so that the write timing and the read timing of the RGB data RGBD of the frame memory 51 do not synchronize. Since the other configuration and operation of the display control circuit 70 of the video-mode RAM capture are similar to those of the display control circuit 60 of the video-mode RAM through, its description will not be repeated. Also in the display control circuit 70 of the video-mode RAM capture, the OSC 40 is not an essential component.

The checksum circuit 33 obtains the checksum value of the RGB data RGBD, and the RGB data RGBD whose checksum value is obtained is written into the frame memory 51 in the frame period regardless of the value. In such a manner, the RGB data RGBD of one screen is written into the frame memory 51 every frame period.

When the count value of the counter 35a becomes 2 as the count set value, the timing generator 35 transmits the RGB data RGBD written into the frame memory 51 to the latch circuit 34 even when the image is not updated. In the case where the obtained checksum value is different from the checksum value stored in the memory 33a, it is determined that the image is updated and, regardless of the count value of the counter 35a, the RGB data RGBD written into the frame memory 51 is transmitted to the latch circuit 34. Therefore, the image displayed in the screen is counter-refreshed or forced-refreshed with the RGB data RGBD written into the frame memory 51.

The RGB data RGBD which is not given to the latch circuit 34 in the RGB data written into the frame memory 51 is held in the frame memory 51 until it is overwritten with the RGB data RGBD given in the following frame period.

In the display control circuit 70 of the video-mode RAM capture, the RGB data RGBD can be held in the frame memory 51. Consequently, in the case where the screen is not updated, it is unnecessary to transmit the data DAT again from the host 1 to the display control circuit 70. The RGB data RGBD taken from the data transmitted from the host 1 is supplied to the checksum circuit 33, and the timing control signals TS such as the vertical sync signal VSYNC are supplied to the timing generator 35. Therefore, the timing of refreshing the screen and the necessary image data can be controlled optionally, so that the pause driving can be realized effectively.

In the present embodiment, it has been described that the RGB data RGBD of the image which is not updated is also written into the frame memory 51. However, the RGB data RGBD of the image which is not updated may be discarded in the checksum circuit 33 without being written into the frame memory 51.

### 2.2 Refresh Operation

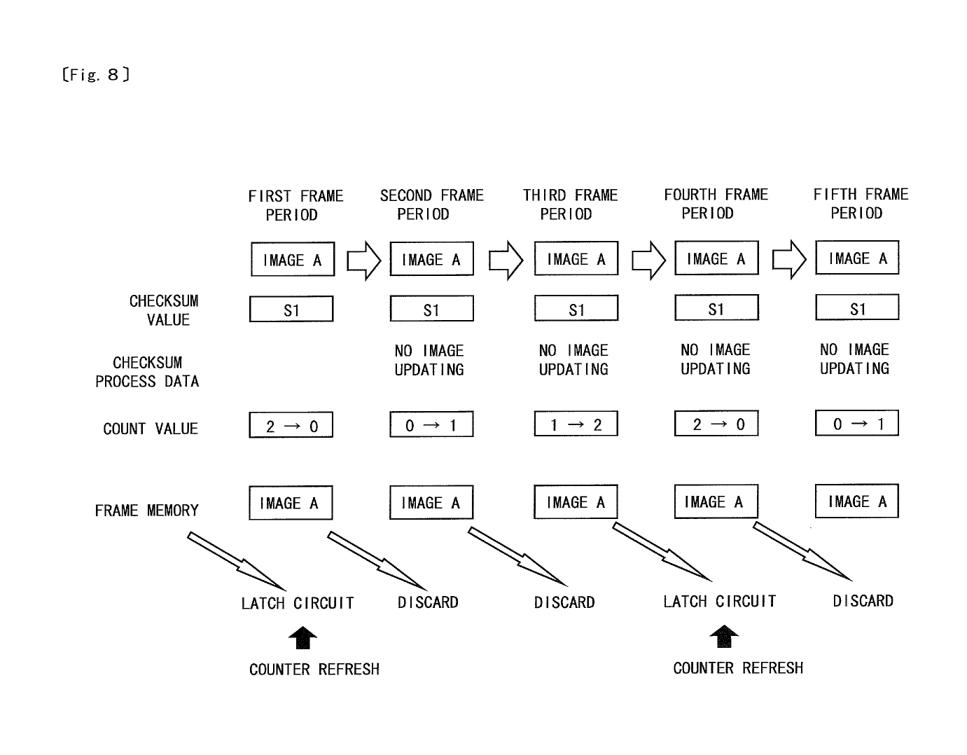

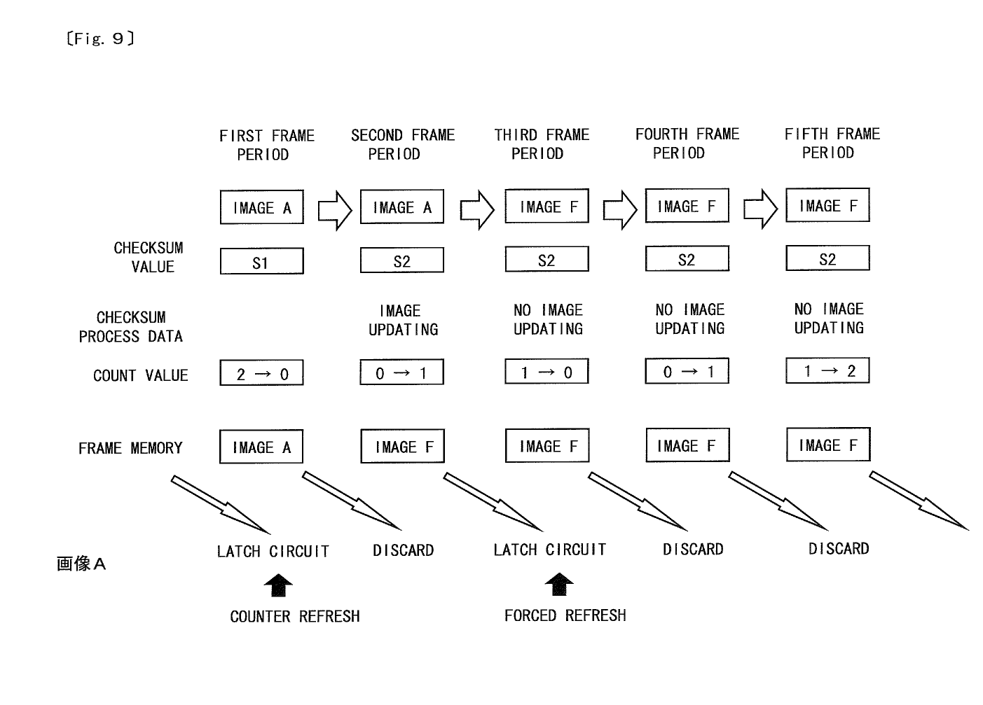

The operation of the display control circuit 70 included in the liquid crystal display device of the present embodiment will be described. FIG. 8 is a diagram illustrating the operation of the display control circuit 70 in the case of performing the counter-refreshing. FIG. 9 is a diagram illustrating the operation of the display control circuit 70 in the case of performing the forced refreshing.

With reference to FIG. 8, description will be given of the operation of the display control circuit 70 in the case of refreshing the screen by the counter refresh even when an image is not updated. Also in this case, when the count value of the counter 35a becomes 2, the counter refresh is performed even when the image is not updated.

As illustrated in FIG. 8, different from the case of the first embodiment, when the RGB data of the image A is given to the checksum circuit 33, the checksum circuit 33 obtains the checksum value and further, regardless of the checksum value, the RGB data of one screen is written into the frame memory 51 in the frame period. For example, the RGB data transmitted to the checksum circuit 33 during a zero frame period (not illustrated) is written into the frame memory 51 during the zero frame period, and is read from the frame memory 51 and given to the latch circuit 34 in the first frame period. The RGB data transmitted to the checksum circuit 33 in the third frame period is written into the frame memory 51 in the third frame period, and is read from the frame memory 51 and given to the latch circuit 34 in the fourth frame period.

The counter refresh will be described using the third and fourth frame periods as an example. In the third frame period, the count value of the counter 35a is 1, and the checksum value of the RGB data is S1. The checksum circuit 33 overwrites the checksum value S1 stored in the memory 33a and writes the RGB data into the frame memory 51. The timing generator 35 sets the count value of the counter 35a to 2 and performs the pause driving. Therefore, the checksum value is stored in the memory 33a and, by comparing the checksum value of the RGB data written into the frame memory 51 and the checksum value of the RGB data supplied to the checksum circuit 33 with each other, whether the image is updated or not is determined. In such a manner, whether the image is updated or not can be easily and reliably determined.

In a fourth frame period, the checksum value of the received RGB data is obtained. Since the obtained checksum value S1 is the same value as the checksum value S1 of the third frame period, it is determined that the image is not updated. However, the count value of the counter 35a becomes 2 as a count set value. The checksum circuit 33 outputs the RGB data to the latch circuit 34 to perform the counter refresh. Consequently, the image A is counter-refreshed. At this time, the checksum circuit 33 overwrites the checksum value S1 stored in the memory 33a with the obtained checksum value S1. The timing generator 35 resets the count value of the counter 35a. Since the other operations are the same as those illustrated in FIG. 3, the description of the operations will not be repeated.

Referring now to FIG. 9, description will be given of the operation of the display control circuit 70 at the time of the forced refresh performed when an image is updated in the course of a predetermined cycle. In this case as well, as illustrated in FIG. 9, different from the case of the first embodiment, when the RGB data of the image A is supplied to the checksum circuit 33, the checksum value is obtained in the checksum circuit 33 and, further, regardless of the checksum value, the RGB data of one screen is written into the frame memory 51 during the frame period. Concretely, the RGB data supplied to the checksum circuit 33 during a zeroth frame period (not illustrated) is written into the frame memory 51 in the zeroth frame period, and is read from the frame memory 51 and transmitted to the latch circuit 34 in the first frame period. The RGB data supplied to the checksum circuit 33 during the second frame period is written into the frame memory 51 during the second frame period, and is read from the frame memory 51 and given to the latch circuit 34 in the third frame period.

The forced refresh will be described using the second and third frame periods as an example. In the second frame period, the checksum value obtained by the checksum circuit 33 is S2 and is different from the checksum value S1 stored in the memory 33a. Therefore, the checksum circuit 33 detects that the image is updated from the image A to the image F, overwrites the checksum value S1 stored in the memory 33a with the obtained checksum value S2, and writes the RGB data into the frame memory 51. The checksum circuit 33 transmits the checksum process data CSD indicating that the image is updated to the timing generator 35. The timing generator 35 sets the count value to 1 and performs the pause driving.

In the third frame period, the count value of the counter 35a is 1. However, the timing generator 35 detects that the image is updated in the second frame period from the checksum process data CSD received in the second frame period. Consequently, even when the count value is smaller than the count set value of 2, the RGB data of the checksum circuit 33 is output to the latch circuit 34. By the operation, the screen is forcedly refreshed, and the image A is updated to the image F. At this time, the checksum circuit 33 overwrites the checksum value S2 stored in the memory 33a with the obtained checksum value S2, and the timing generator 35 resets the count value. Since the counter refresh and the other operations are the same as those illustrated in FIG. 4, their description will not be repeated.

In such a manner, in the case of continuously displaying the image A, the liquid crystal display device repeats an operation of performing the pause driving for two frame periods and, after that, performing the counter refresh once. However, when the image is updated during the pause driving, the pause driving is interrupted, and the forced refresh is performed to update the image A displayed in the screen to the image F.

In the first embodiment, in the case where an image is updated, the RGB data given in the frame period is discarded, and the RGB data given in the following frame period is supplied to the latch circuit 34. Consequently, the image displayed in the display unit 15 is displayed based on the RGB data given in the frame period subsequent to the frame period in which the image is updated. On the other hand, in the present embodiment, all of the RGB data is written into the frame memory 51, so that the image displayed in the display unit 15 is the image when the image is updated but is displayed while being delayed only by one frame period at the maximum from the frame period in which the image is updated.

Since the RGB data of the updated image is written into the frame memory 51, even in the pause period, the RGB data of an image in an arbitrary line, an image at an arbitrary point, or an image of an arbitrary block can be rewritten to the RGB data written into the frame memory 51. In such a manner, also in the case where a part of the screen, not the whole screen, is updated, similarly, the updating of the image is detected, and the forced refresh is performed.

The functions and connections of the other circuits are the same as those in the case of the first embodiment, so that their description will not be repeated.

### 2.3 Timing Chart

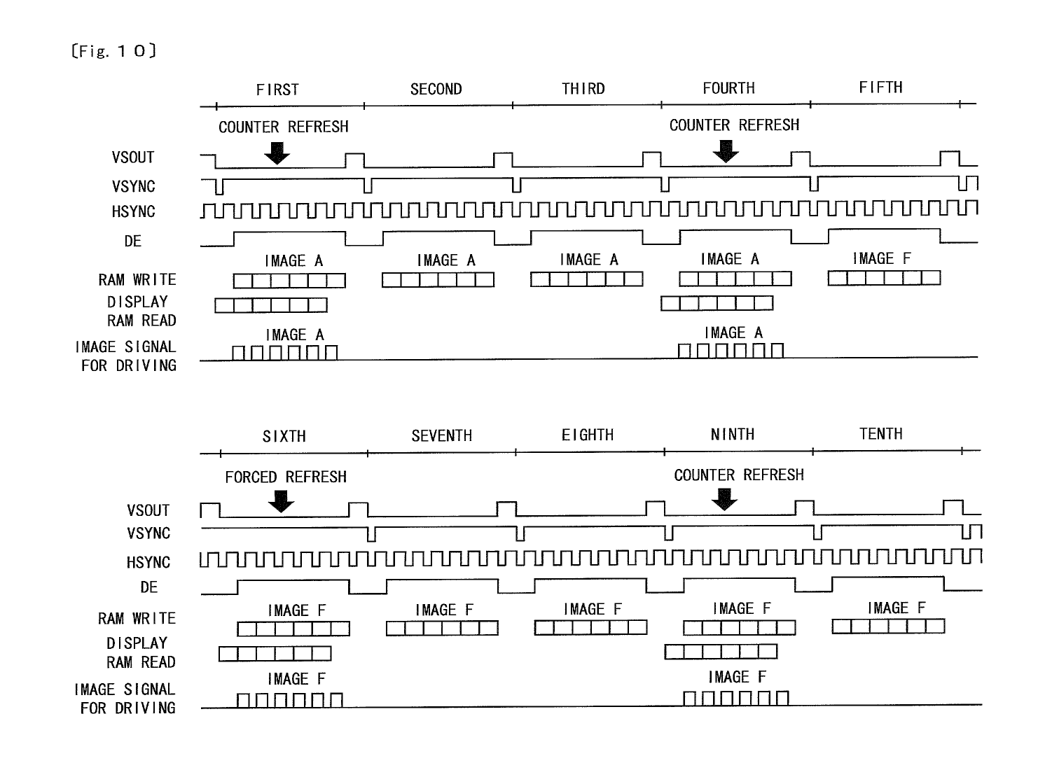

FIG. 10 is a timing chart illustrating the operation of the liquid crystal display device according to the present embodiment. FIG. 10 illustrates, in order from the above, the vertical sync output signal VSOUT, the vertical sync signal VSYNC, the horizontal sync signal HSYNC, the data enable signal DE, RGB data (RAM writing), display RAM read, and an image signal for driving. The display RAM reading indicates timing of giving the RGB data written into the frame memory 51 to the latch circuit 34. In FIG. 10, the vertical sync signal VSYNC and the horizontal sync signal HSYNC are signals of negative logic.

As illustrated in FIG. 10, in the first frame period, the vertical sync output signal VSOUT is transmitted from the timing generator 35 to the host 1. The host 1 receives the vertical sync output signal VSOUT and transmits a control signal such as the vertical sync signal VSYNC to the liquid crystal display device in sync with the rising edge of the vertical sync output signal VSOUT. In sync with the falling edge of the horizontal sync signal HSYNC, the data enable signal DE indicative of the range of valid RGB data rises from the L level to the H level, and the RGB data is given to the checksum circuit 33 during a period in which the data enable signal DE is at the H level. In the following, the description of the vertical sync output signal VSOUT will not be repeated.

Since the count value of the counter 35a becomes 2 as the counter set value at this time, the counter refresh is performed. The RGB data used for the counter refresh is RGB data whose checksum value is obtained by the checksum circuit 33 in the zeroth frame period (not illustrated) and which is written into the frame memory 51. The RGB data written into the frame memory 51 is read and transmitted to the latch circuit 34 in the first frame period. Display RAM reading is performed prior to the timing of writing the RGB data into the frame memory 51. Therefore, the RGB data is supplied to the latch circuit 34 by the display RAM reading, and the image A displayed in the screen is refreshed.

In the second and third frame periods, neither the counter refresh nor the forced refresh is performed, and the liquid crystal display device performs the pause driving. Consequently, the screen is not refreshed.

In the fourth frame period, the count value of the counter 35a becomes 2 as the counter set value which is set in the command register 37. Consequently, in a manner similar to the first frame period, counter-refresh is performed, and the image A displayed in the screen is refreshed.

In the fifth frame period, although the count value of the counter 35a is 0, the checksum value of the RGB data given to the checksum circuit 33 is different from the checksum value stored in the memory 33a. Consequently, it is determined that the RGB data given to the checksum circuit 33 is the RGB data of the image F different from the image A in the fourth frame period, and the checksum value stored in the memory 33a is rewritten with the obtained checksum value. The RGB data of the image F is written into the frame memory 51 in the fifth frame period but is not transmitted to the latch circuit 34. Consequently, in the fifth frame period, the forced refresh is not performed. In the fifth frame period, the checksum process data CSD indicating that the RGB data is updated is transmitted from the checksum circuit 33 to the timing generator 35.

In the sixth frame period, the count value of the counter 35a is 1, and the counter refresh is not performed. However, in the fifth frame period, the updating of the image from the image A to the image F is detected. Therefore, in the sixth frame period, the RGB data written into the frame memory 51 is read and transmitted to the latch circuit 34. Concretely, when the RGB data of the image F is transmitted to the checksum circuit 33 also in the sixth frame period, the checksum circuit 33 obtains the checksum value of the RGB data, and writes the RGB data of the image F into the frame memory 51 in the sixth frame period. The RGB data of the image F written into the frame memory 51 in the fifth frame period is display-RAM-read and supplied to the latch circuit 34. Therefore, the image A displayed in the screen is forced-refreshed to the image F. As described above, in a manner similar to the first embodiment, the image A displayed in the display unit 15 in the fifth frame period is forced-refreshed and the image F is displayed in the sixth frame period. However, different from the case of the first embodiment, in the embodiment, the image F updated in the fifth frame period is displayed.

In the seventh and eighth frame periods, neither the counter refresh nor the forced refresh is performed, and the liquid crystal display device performs the pause driving. Consequently, the screen is not refreshed.

In the ninth frame period, the count value of the counter 35a becomes 2 as the counter set value and, therefore, in a manner similar to the case of the first frame period, the counter refresh is performed and the image F displayed in the screen is refreshed.

In the tenth frame period, neither the counter refresh nor the forced refresh is performed, and the liquid crystal display device performs the pause driving. Consequently, the screen is not refreshed.

### 2.4 Effects

By providing the display control circuit 70 of the liquid crystal display device according to the present embodiment with the frame memory 51, the RGB data RGBD transmitted from the host 1 is written into the frame memory 51 regardless of whether it is updated or not. Consequently, the RGB data RGBD can be always read and displayed, so that the pause driving can be performed effectively, and display quality can be maintained high. The updated RGB data RGBD is always displayed in the following frame period, so that the RGB data RGBD is not discarded. Since the other effects are the same as those in the case of the first embodiment, their description will not be repeated.

### 2.5 Modification

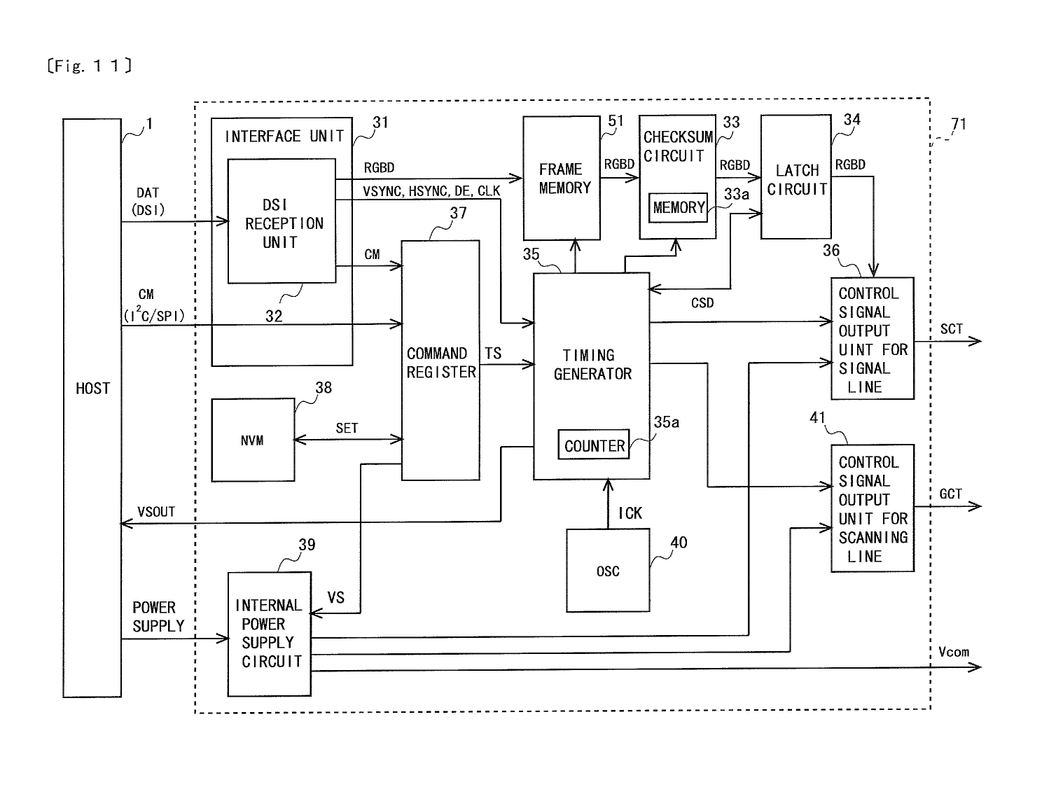

FIG. 11 is a block diagram illustrating the configuration of a display control circuit 71 included in a liquid crystal display device according to a modification of the present embodiment. In FIG. 11, the same reference numerals are designated to the same components as those illustrated in FIG. 7 throughout this description.

In the display control circuit 70 illustrated in FIG. 7, the checksum circuit 33 is provided between the DSI reception unit 32 and the frame memory 51, and the RGB data whose checksum value is obtained by the checksum circuit 33 is transmitted to the latch circuit 34. However, the position in which the checksum circuit 33 is provided is not limited to the above and, as illustrated in FIG. 11, the checksum circuit 33 may be provided between the frame memory 51 and the latch circuit 34. Although not illustrated, it may be provided between the latch circuit 34 and the control signal output unit for signal line 36. Also in the case of providing the checksum circuit 33 between the frame memory 51 and the latch circuit 34 or between the latch circuit 34 and the control signal output unit for signal line 36 as described above, effects similar to those of the liquid crystal display device according to the present embodiment are produced.

### 3. Third Embodiment

Since a configuration of an active matrix-type liquid crystal display device according to a third embodiment of the present invention is the same as that of the active matrix-type liquid crystal display device according to the first embodiment illustrated in FIG. 1, a block diagram illustrating the configuration of the liquid crystal display device and description of the device will not be repeated.

### 3.1 Command Mode RAM Writing

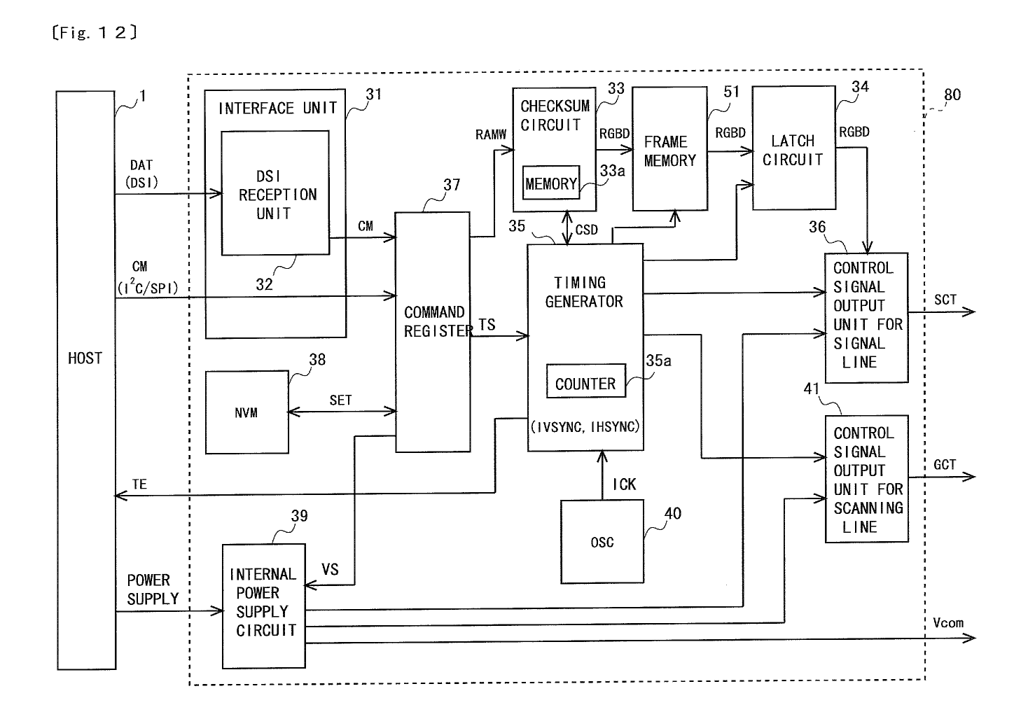

FIG. 12 is a block diagram illustrating the configuration of a display control circuit 80 corresponding to command-mode RAM writing in the present embodiment (hereinbelow, called “the display control circuit 80 of the command-mode RAM writing”). The display control circuit 80 of the command-mode RAM writing has a configuration similar to that of the display control circuit 70 of the video-mode RAM capture as illustrated in FIG. 4 but the kinds of data included in the data DAT are different.

The data DAT in the command mode includes the command data CM but does not include the RGB data RGBD, the vertical sync signal VSYNC, the horizontal sync signal HSYNC, the data enable signal DE, and the clock signal CLK. The command data CM in the command mode includes data on images and data on various timings. The command register 37 transmits RAM write data RAMW corresponding to the data on an image in the command data CM to the checksum circuit 33. The RAM write data RAMW corresponds to the RGB data RGBD. In the command mode, the timing generator 35 does not receive the vertical sync signal VSYNC and the horizontal sync signal HSYNC, so that based on an internal clock signal ICK and the timing control signal TS, an internal vertical sync signal IVSYNC and an internal horizontal sync signal IHSYNC corresponding to those signals are internally generated. Based on the internal vertical sync signal IVSYNC and the internal horizontal sync signal IHSYNC, the timing generator 35 controls the frame memory 51, the latch circuit 34, the control signal output unit for signal line 36, and the control signal output unit for scanning line 41. The timing generator 35 transmits the transmission control signal TE corresponding to the vertical sync output signal VSOUT to the host 1. In such a manner, even when the timing control signal TS of the vertical sync signal VSYNC is not given from the outside, the liquid crystal display device can be driven.

The functions and connections of the other circuits are the same as those in the display control circuit 70 of the video-mode RAM capture of the second embodiment, so that their description will not be repeated. In the present embodiment, it has been described that the RGB data of an image which is not updated is also written into the frame memory 51. However, the RGB data of an image which is not updated may be discarded by the checksum circuit 33 without being written into the frame memory 51.

Since a diagram illustrating the operation of the display control circuit 80 in the case of performing the counter refresh and a diagram illustrating the operation of the display control circuit 80 in the case of performing the forced refresh are the same as FIG. 8 and FIG. 9, respectively, their diagrams and description will not be repeated.

### 3.2 Timing Chart

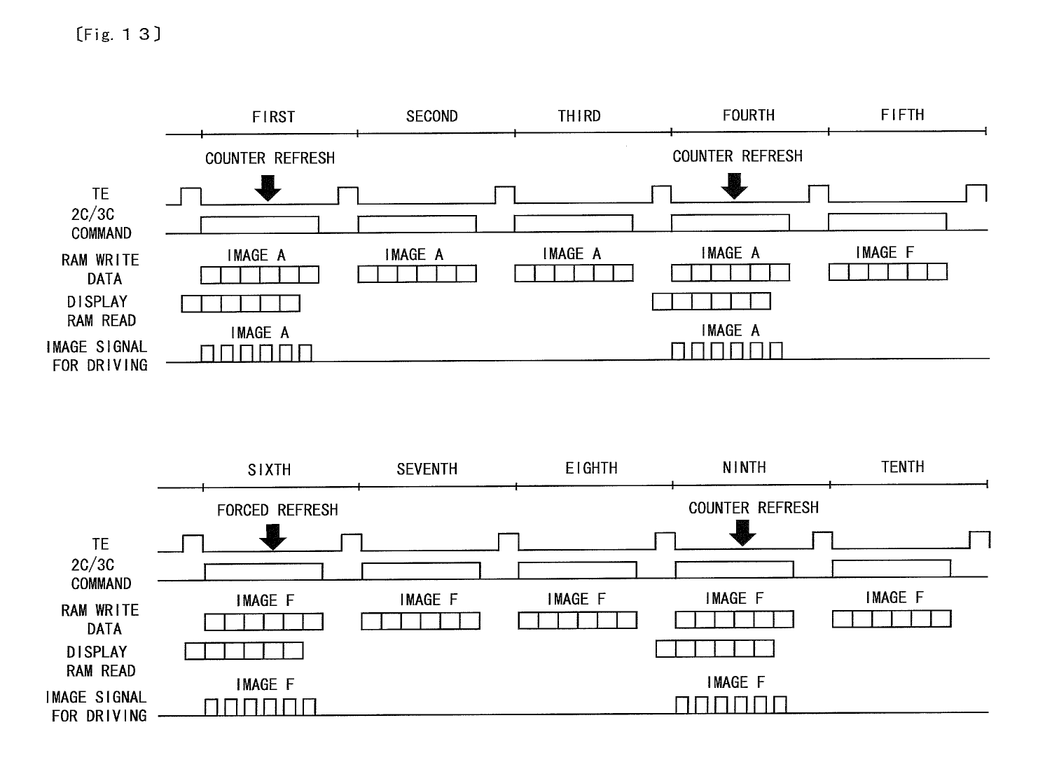

FIG. 13 is a timing chart illustrating the operation of the liquid crystal display device according to the present embodiment. FIG. 13 illustrates, in order from the above, a transmission control signal TE, a 2C/3C command, RAM write data, display RAM reading, and an image signal for driving. The transmission control signal TE is a signal designating the timing of transmitting the command data CM from the host 1 to the DSI reception unit 32 such that tearing does not occur, and is transmitted from the timing generator 35 to the host 1. The 2C/3C command is an RAM write command for designating the range of valid RGB data. The display RAM reading indicates the timing of giving the RGB data written into the frame memory 51 to the latch circuit 34. In FIG. 13, the transmission control signal TE is a signal of the positive logic.

As illustrated in FIG. 13, in the first frame period, the transmission control signal TE is transmitted from the timing generator 35 to the host 1. The host 1 receives the transmission control signal TE and transmits the 2C/3C command to the liquid crystal display device in sync with the falling edge of the transmission control signal TE. When the 2C/3C command is transmitted, the RAM write data is given to the checksum circuit 33. In the following, the description of the transmission control signal TE will not be repeated. The transmission control signal TE will be also called a transmission request signal.

At this time, the count value of the counter 35a is 2, and it is the timing of performing the counter refresh. Prior to writing of the RAM write data to the checksum circuit 33, the display RAM reading is performed first. By the operation, the RGB data written into the frame memory 51 is transmitted to the latch circuit 34 in the zeroth frame period. Thus, the screen is counter-refreshed with the image A displayed by the RAM write data transmitted in the zeroth frame period. At this time, the count value of the counter 35a is reset. As described above, by performing the display RAM reading first, a plurality of images are prevented from being displayed in one frame period.

After performing the display RAM reading, RAM writing is performed on the checksum circuit 33, and the RAM write data is transmitted to the checksum circuit 33. The checksum circuit 33 converts the RAM write data to RGB data to obtain a checksum value and, further, writes the checksum value to the frame memory 51. At this time, to the latch circuit 34, the RGB data supplied to the checksum circuit 33 in the zeroth frame period (not illustrated) and written into the frame memory 51 is given.

In the second frame period, the count value of the counter 35a is 0, so that the counter refresh is not performed. Since the RAM write data indicative of the same image A as that in the first frame period is given to the checksum circuit 33, the checksum value of the data matches the checksum value stored in the memory 33a, and the forced refresh is not also performed. Consequently, the liquid crystal display device performs the pause driving.

Hereinafter, similarly, in the third frame period, like in the second frame period, neither the counter-refresh nor the forced refresh is performed. In the fourth frame period, like in the first frame period, the counter refresh is performed.

In the fifth frame period, the image A is updated to the image F. The checksum circuit 33 receives the RAM write data expressing the image F, obtains the checksum value, stores the checksum value into the memory 33a, and writes the RGB data obtained from the RAM write data into the frame memory 51. In the fifth frame period, neither the counter refresh nor the forced refresh is performed, so that the liquid crystal display device performs the pause driving.

In the sixth frame period, the count value of the counter 35a is 1, and the counter refresh is not performed. However, in the fifth frame period, the updating of the image from the image A to the image F is detected, so that, in the sixth frame period, the forced refresh is performed. Concretely, when the RAM write data of the image F which is the same as that in the fifth frame period is transmitted to the checksum circuit 33, the checksum circuit 33 obtains the checksum value. Subsequently, the checksum circuit 33 compares the obtained checksum value with the checksum value stored in the memory 33a to confirm that both of them are the same image F.

The display RAM reading is performed in advance, and the RGB data written into the frame memory 51 in the fifth frame period is read and transmitted to the latch circuit 34. Consequently, by updating the image A to the image F, the screen is forcedly refreshed. After that, the checksum circuit 33 writes the RGB data into the frame memory 51.

Hereinafter, similarly, in the seventh, eighth, and tenth frame periods, like in the second frame period, neither the counter refresh nor the forced refresh is performed. In the ninth frame period, like in the first frame period, the counter refresh is performed.

### 3.3 Effects

Since the effects of the liquid crystal display device according to the present embodiment are the same as those of the liquid crystal display devices of the first and second embodiments, their description will not be repeated.

### 3.4 Modification

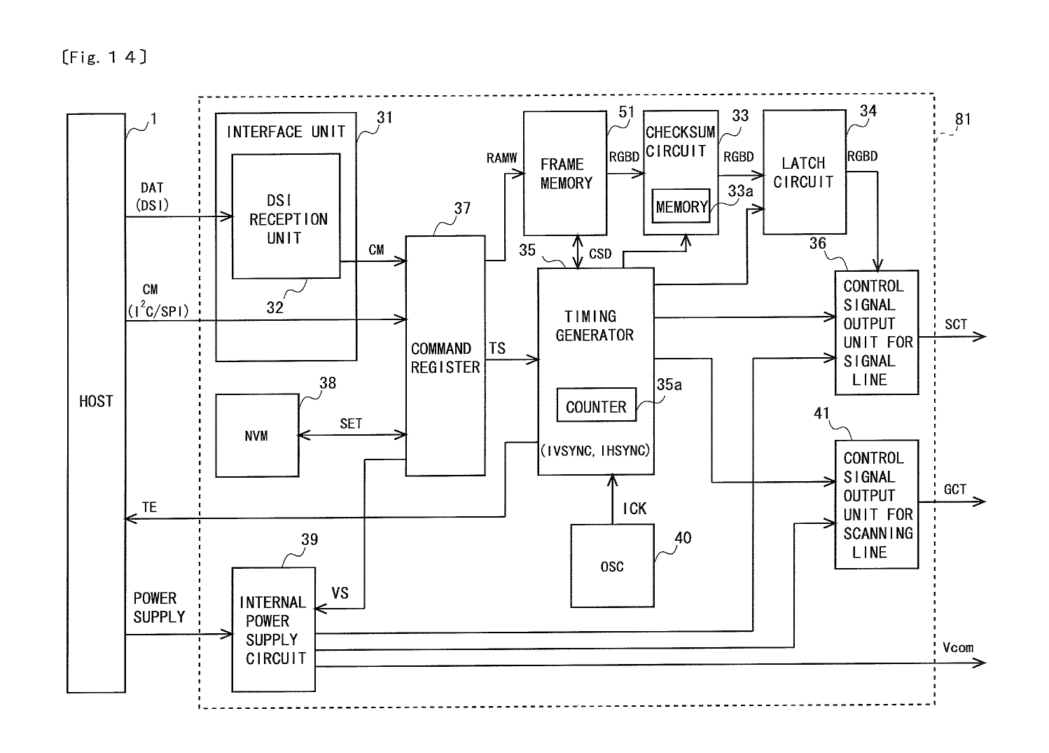

FIG. 14 is a block diagram illustrating a configuration of a display control circuit 91 included in a liquid crystal display device according to a modification of the present embodiment. In FIG. 14, the same reference numerals are designated to the same components as those illustrated in FIG. 12 throughout this description.

In the display control circuit 80 illustrated in FIG. 12, the checksum circuit 33 is provided between the interface unit 31 and the frame memory 51, and the RGB data whose checksum value is obtained by the checksum circuit 33 is written into the frame memory 51. However, the position in which the checksum circuit 33 is provided is not limited to the above and, as illustrated in FIG. 14, the checksum circuit 33 may be provided between the frame memory 51 and the latch circuit 34. Although not illustrated in FIG. 14, it may be provided between the latch circuit 34 and the control signal output unit for signal line 36. Also in the case of providing the checksum circuit 33 between the frame memory 51 and the latch circuit 34 or between the latch circuit 34 and the control signal output unit for signal line 36 as described above, effects similar to those of the liquid crystal display device according to the present embodiment are produced.

### 4. Alternating Current Driving of Liquid Crystal Display Device

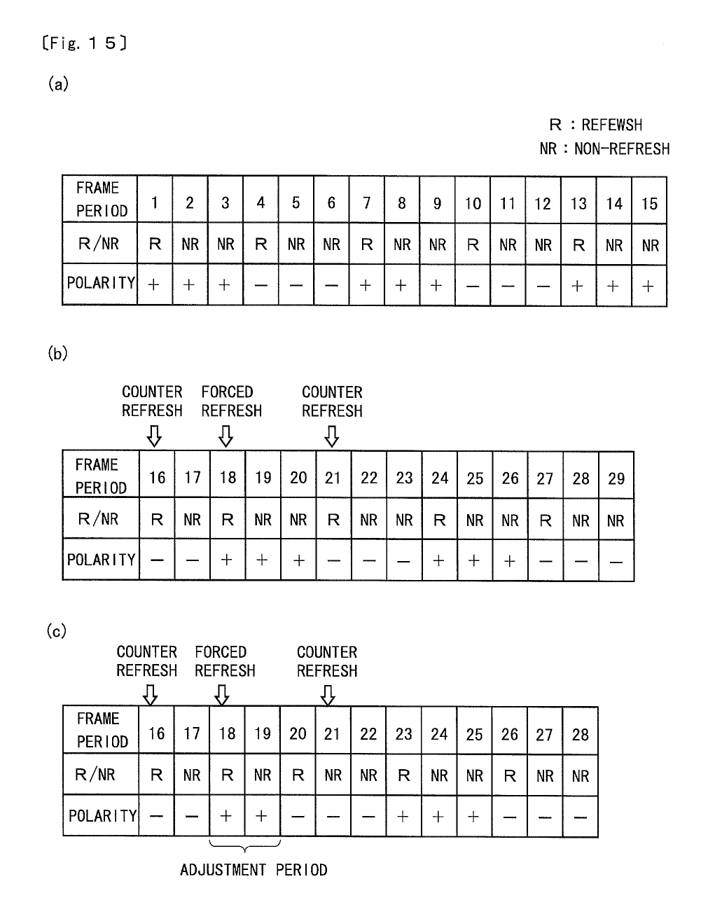

FIGS. 15(a), 15(b), and 15(c) are diagrams illustrating polarities of voltages applied across the pixel electrode 23 and the opposed electrode 24 in each of frame periods at the time of AC driving the liquid crystal display device. More specifically, FIG. 15(a) is a diagram illustrating the polarities of voltages applied across the pixel electrode 23 and the opposed electrode 24 in the frame periods at the time of counter refresh, FIG. 15(b) is a diagram illustrating the polarities of voltages applied across the pixel electrode 23 and the opposed electrode 24 in the frame periods when an adjustment period is not provided after performing forced refresh, and FIG. 15(c) is a diagram illustrating the polarities of voltages applied across the pixel electrode 23 and the opposed electrode 24 in the frame periods when an adjustment period is provided after performing forced refresh.

First, referring to FIG. 15(a), the case where the counter refresh is performed will be described. The counter refresh is repetition of operation of performing, after performing the refresh drive once, the pause driving (non-refresh-driving) twice. Positive voltage is applied across the pixel electrode 23 and the opposed electrode 24 from the first frame period to the third frame period, negative voltage is applied across the pixel electrode 23 and the opposed electrode 24 from the fourth frame period to the sixth frame period, and positive voltage is applied across the pixel electrode 23 and the opposed electrode 24 from the seventh frame period to the ninth frame period. Hereinafter, similarly, the voltages of opposite polarities are alternately applied across the pixel electrode 23 and the opposed electrode 24. In FIG. 15(a), R expresses refresh driving and NR expresses the pause driving. The counter refresh illustrated in FIGS. 15A(a), 15B(b), and 15C(c) indicates that the operation of performing the refresh driving once and, after that, performing the pause driving twice is repeated. The number of times of the refresh driving and that of the pause driving are not limited to the above but can be arbitrarily set. Since the common voltage Vcom applied to the opposed electrode 24 is generated by the internal power supply circuit 39, the internal power supply circuit 39 is also called a common voltage generation circuit.

Referring now to FIG. 15(b), the case where an image is updated during the counter refresh will be described. As illustrated in FIG. 15(b), since image data transmitted from the host 1 is updated in the course of the 17th frame period, the forced refresh is performed in the 18th frame period, and the pause driving is performed in the 19th and 20th frame periods. At this time, the negative voltage is applied across the pixel electrode 23 and the opposed electrode 24 in the 16th and 17th frame periods, and the positive voltage is applied from the 18th frame period to the 20th frame period. As a result, in the period from the 16th frame period to the 20th frame period, the period in which the positive voltage is applied and the period in which the negative voltage is applied are different from each other, and a problem such as flicker occurs in an image displayed in the screen.

With reference to FIG. 15(c), description will be given of a voltage application method which does not cause such a problem in the case where an image is updated in the course of the counter refresh. Like in the case illustrated in FIG. 15(b), the negative voltage is applied to the opposed electrode 24 in the two frame periods of the 16th and 17th frame periods. Consequently, an adjustment period is provided between the 18th and 19th frame periods. In the adjustment period, the positive voltage is applied across the pixel electrode 23 and the opposed electrode 24. By providing the adjustment period, in the period from the 16th frame period to the 19th frame period, the period in which the positive voltage is applied and the period in which the negative voltage is applied become equal to each other. Therefore, the problem such as flicker in an image displayed in the display unit 15 is solved. After that, from the 20th frame period, the positive voltage and the negative voltage are applied across the pixel electrode 23 and the opposed electrode 24 in normal cycles.

In the case of FIG. 15(c), the liquid crystal display device counts, by the counter 35a provided for the checksum circuit 33, the number of recent frame periods (two in this example) which are the 16th frame period in which the refresh driving is performed and the 17th frame period in which the pause driving is interrupted. The timing generator 35 sets the same number of frame periods as the counted number of frame periods as the adjustment period.

### 5. Modification Common to Embodiments

In each of the foregoing embodiments, to determine whether images expressed by the RGB data are the same or not, a checksum value of image data of one screen is obtained by the checksum circuit 33. Consequently, the checksum circuit 33 functions as an image detection circuit.

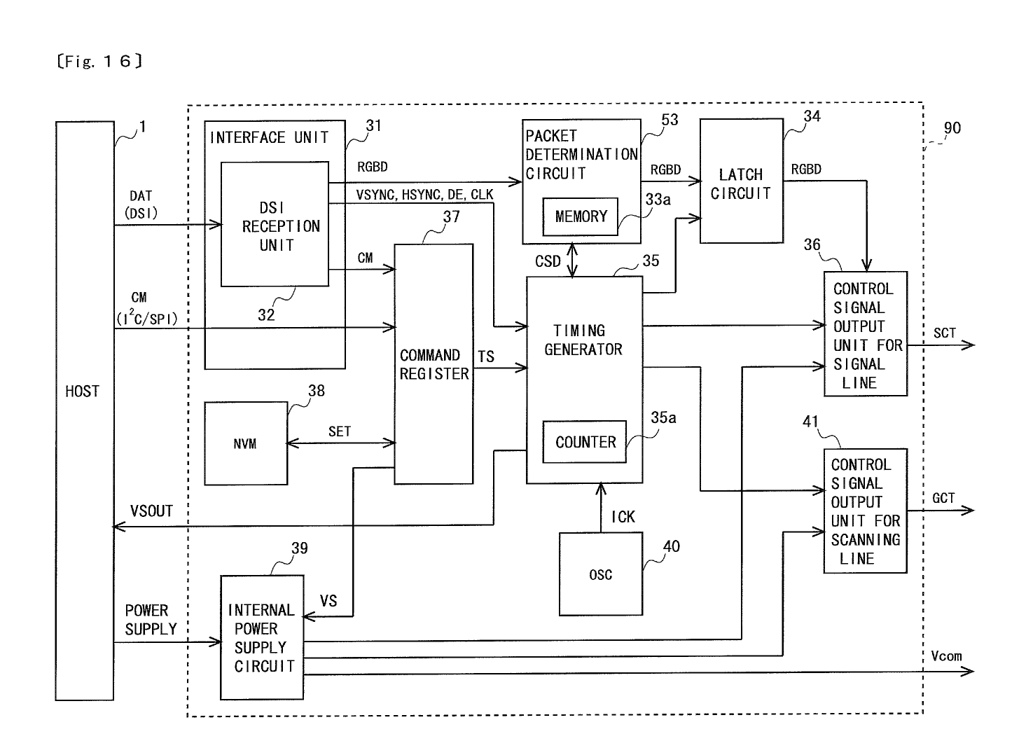

However, the image detection circuit having such a function is not limited to the checksum circuit 33. For example, the header of image data transmitted from the host 1 may be used. FIG. 16 is a block diagram illustrating the configuration of a display control circuit 90 using the header of image data. The same reference numerals are designated to the same components as those illustrated in FIG. 2, in the components illustrated in FIG. 16.

The display control circuit 90 is provided with a packet determination circuit 53 in place of the checksum circuit 33 illustrated in FIG. 2. When the display control circuit 90 receives a command transmitted from the host 1, the packet determination circuit 53 reads a packet value written into an image determination packet included in the header of the command. Then, when the read packet value is zero, the packet determination circuit 53 determines that the image is not updated. When the read packet value is one, the packet determination circuit 53 determines that the image is updated. In such a manner, whether the image data is updated or not can be easily and reliably determined.

Although the description has been given of a modification of the display control circuit 60 illustrated in FIG. 2, also in the display control circuit 70 illustrated in FIG. 7 or the display control circuit 80 illustrated in FIG. 12, by replacing the checksum circuit 33 with the packet determination circuit 53, whether the image is updated or not can be determined based on the image determination packet.

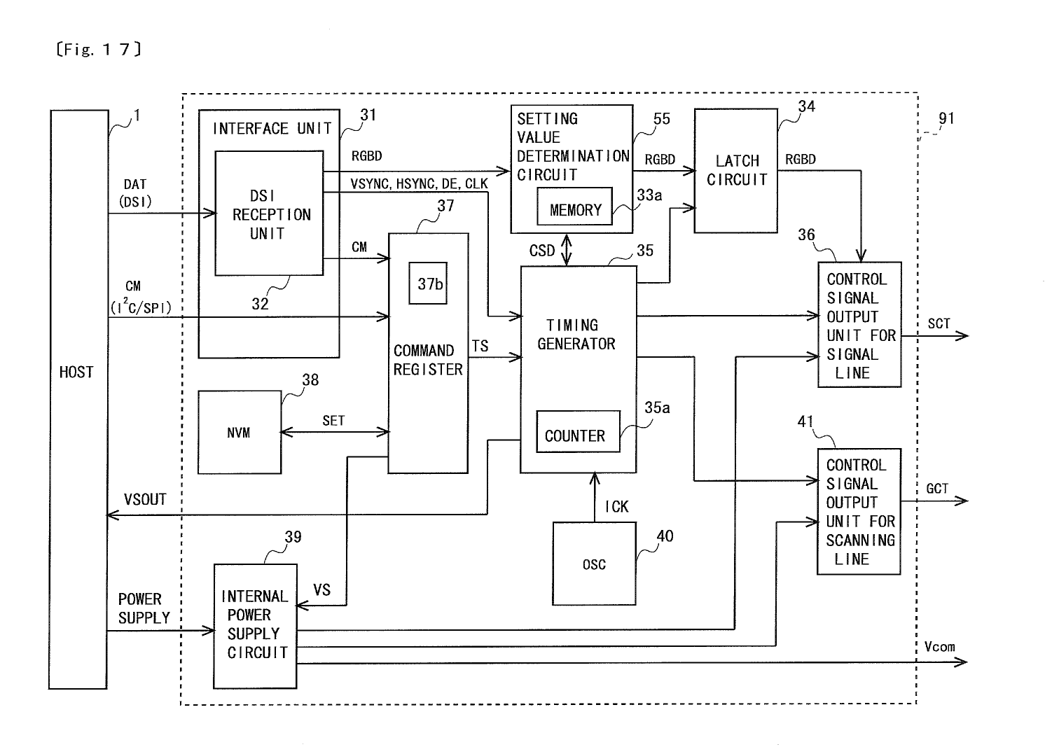

FIG. 17 is a block diagram illustrating the configuration of a display control circuit 91 of presetting a frame in which an image is updated. The same reference numerals are designated to the same components as those illustrated in FIG. 2, in the components illustrated in FIG. 17. In the display control circuit 60 illustrated in FIG. 2, a frame in which an image is updated in frames to be transmitted is transmitted in advance from the host 1 to the command register 37 and is stored in the memory 37b in the command register 37. A set value determination circuit 55 is provided in place of the checksum circuit 33. Each time RGB data is given to the set value determination circuit 55, the set value stored in the memory 37b in the command register 37 is read by the timing generator 35, and whether the image supplied to the set value determination circuit 55 is an updated image or not is determined. Such a set value determination circuit 55 also functions as an image detection circuit. With the configuration, determination of whether the image is an updated image or not can be made promptly. The set value stored in the memory 37b in the command register 37 can be freely rewritten from the outside.

Although the description has been given of a modification of the display control circuit 60 illustrated in FIG. 2, also in the display control circuit 70 illustrated in FIG. 7 or the display control circuit 80 illustrated in FIG. 12, by replacing the checksum circuit 33 with the set value determination circuit 55, whether the image is updated or not can be determined based on the set value stored in the memory 37b in the command register 37. Thus, since the period from the refresh performed most recently until updating of data is counted by the counter 35a in the timing generator 35, the counting can be performed easily and reliably.

### 6. Others

Although the liquid crystal display device has been described as an example in each of the foregoing embodiments, the present invention is not limited thereto. The present invention can be also applied to other display devices such as an organic EL (Electro Luminescence) display device.

### INDUSTRIAL APPLICABILITY

The present invention is applied to a display device capable of performing pause driving which does give strange feeling to a viewer on a displayed image by updating the image while interrupting the pause driving also in the case where the image is updated in the course of the pause driving.

### DESCRIPTION OF REFERENCE CHARACTERS

1: HOST
15: DISPLAY UNIT
20: PIXEL FORMATON PART
21: THIN FILM TRANSISTOR (SWITCHING ELEMENT)
22: LIQUID CRYSTAL CAPACITANCE
23: PIXEL ELECTRODE
24: OPPOSED ELECTRODE
31: INTERFACE UNIT
32: DSI RECEPTION UNIT
33: CHECKSUM CIRCUIT (IMAGE DETECTION CIRCUIT)
33a: MEMORY
34: LATCH CIRCUIT
35: TIMING GENERATOR (TIMING CONTROL CIRCUIT)
35a: COUNTER
37: COMMAND REGISTER
39: INTERNAL POWER SUPPLY CIRCUIT (COMMON VOLTAGE GENERATION CIRCUIT)
51: FRAME MEMORY
53: PACKET DETERMINATION CIRCUIT
60, 61, 70, 71, 80, 81, 90: DISPLAY CONTROL CIRCUIT

1. A display device comprising:
a display unit including a plurality of pixel formation portions each having a switching element and a pixel capacitance connected to the switching element;
a drive circuit that drives the display unit; and
a display control circuit that controls the drive circuit based on image data transmitted from the outside,
wherein the display control circuit includes an image detection circuit that detects updating of an image expressed by the image data, and
when updating of the image expressed by the image data is detected during a pause driving performed in predetermined cycles such that a refresh period for refreshing a screen of the display unit and a non-refresh period for pausing refreshing of the screen appear at a predetermined rate, the image detection circuit interrupts the pause driving and forcedly refreshes the screen of the display unit.

2. The display device according to claim 1, wherein the display control circuit further includes a timing control circuit having a counter that counts the number of times of the non-refresh periods, and
when the number of times counted by the counter becomes a predetermined value, the timing control circuit refreshes the screen of the display unit by the image data.

3. The display device according to claim 1, wherein the image detection circuit determines whether the image is updated or not based on information included in the image data and, when it is determined that the image is updated, outputs the image data to the drive circuit in the following frame period.

4. The display device according to claim 1, wherein the display control circuit further includes a rewritable frame memory which can hold the image data,
the image detection circuit determines whether the image is an updated image or not based on information included in the image data, and writes the image data into the frame memory in a frame period in which the image data is received, and
at the time of displaying the updated image in the display unit, the image data is read from the frame memory and transmitted to the drive circuit.

5. The display device according to claim 4, wherein the image detection circuit determines that the image data is data of the updated image or not by comparing the image data with image data of a preceding frame stored in the frame memory.

6. The display device according to claim 4, wherein the display control circuit further includes an interface unit which takes the image data and a timing control signal from data transmitted from the outside,
the image data is written into the frame memory, and the timing control signal is supplied to a timing control circuit.

7. The display device according to claim 6, wherein the display control circuit further includes a command register which outputs the image data as RAM write data based on a command transmitted from the outside, and
the timing control circuit internally generates the timing control signal and outputs the generated timing control signal.

8. The display device according to claim 4, wherein before the image data is written into the frame memory, image data held in the frame memory is read.

9. The display device according to claim 1, wherein the display control circuit further includes a timing control circuit,
the timing control circuit transmits a transmission request signal requesting transmission of data including the image data to an external electronic device, and
the external electronic device transmits the data in sync with the transmission request signal.

10. The display device according to claim 1, wherein the image detection circuit is a checksum circuit having a memory, and
the checksum circuit checks whether the image data is the same as image data in a preceding frame or not by comparing a checksum value obtained by performing checksum operation on the image data with a checksum value stored in the memory.

11. The display device according to claim 1, wherein the image detection circuit determines whether the image data is data of an updated image or not based on image update information written into an image determination packet included in a header of the image data.

12. The display device according to claim 1, wherein the display control circuit further includes a command register which pre-stores image update information indicating whether the image data to be transmitted is data of an updated image or not, and
each time the image data is received, the image detection circuit reads the image update information stored in the command register and determines whether the image data is data of the updated image or not.

13. The display device according to claim 12, wherein the image update information can be changed from the outside.

14. The display device according to claim 1, wherein the pixel capacitance includes a pixel electrode connected to the switching element and an opposed electrode to which a common voltage is applied,
the display control circuit further includes a common voltage generation circuit for generating the common voltage by inverting polarity of a voltage applied across the pixel electrode and the opposed electrode every predetermined cycle, and
when the image detection circuit detects that the image data is updated, the common voltage generation circuit applies the common voltage of a polarity different from that when the updating of the image is detected across the opposed electrode and the pixel electrode, in the same period as a period since an immediately preceding scanning period until the image data is updated.

15. The display device according to claim 14, wherein the display control circuit further includes a timing control circuit having a counter, and
the timing control circuit counts, by the counter, a period since a most recent refresh until the image data is updated.

16. The display device according to claim 1, wherein the switching element is a thin film transistor having a control terminal connected to a scanning line formed in the display unit, a first conduction terminal connected to a signal line formed in the display unit, a second conduction terminal connected to a pixel electrode in the display unit so that a voltage according to an image to be displayed is applied, and a channel layer made by oxide semiconductor.

17. A method of driving a display device,
the display device comprising:
a display unit including a plurality of pixel formation portions;
a drive circuit that drives the display unit; and
a display control circuit that controls the drive circuit based on image data transmitted from the outside,
wherein the display control circuit includes an image detection circuit that detects updating of an image expressed by the image data,
the method comprising:
a step, when updating of the image expressed by the image data transmitted from the outside is detected during a pause driving performed on the screen of the display unit such that a refresh period for refreshing the screen of the display unit and a non-refresh period for pausing refreshing of the screen appear at a predetermined rate, of interrupting the pause driving and forcedly refreshing the screen of the display unit.

18. The method of driving a display device according to claim 17, wherein the step of forcedly refreshing further comprises:
a step of determining whether the image data is data of an updated image or not based on information included in the image data; and
a step, when the image data is determined as data of the updated image, of outputting the image data to the drive circuit in the following frame period.

19. The method of driving a display device according to claim 17, wherein the display control circuit further includes a rewritable frame memory which can hold the image data, the method further comprising:
a step of determining whether the image data is data of an updated image or not based on information included in the image data;
a step, when the image data is determined as data of the updated image, of writing the image data into the frame memory in a frame period in which the image data is received; and
a step, at the time of displaying an image in the display unit, of reading the image data from the frame memory and transmitting the read image data to the drive circuit.
